(19) United States
(12) Patent Application Publication
(10) Pub. No.: US 2020/0397019 A1
(43) Pub. Date: Dec. 24, 2020

(54) A DRY OILSEED MEAL PROTEIN FRACTION

(71) Applicant: AVRIL, Paris (FR)

(72) Inventors: Stéphane FROUEL, Noyal sur Vilaine (FR); Stéphane PAILLER, Labastide d'Armagnac (FR); Aline SPIRAERS, Dunkerque (FR)

(21) Appl. No.: 16/975,072

(22) PCT Filed: Feb. 22, 2019
(86) PCT No.: PCT/EP2019/054444

§ 371 Date: Aug. 21, 2020

(30) Foreign Application Priority Data
Feb. 23, 2018 (EP) 18305188.7

(51) Int. Cl. A23J 1/14; A23K 10/30; A23K 20/147

(52) U.S. Cl. CPC A23J 1/146; A23K 50/80; A23K 20/147; A23K 10/30

(57) ABSTRACT

A protein-rich fraction from oilseed meal of sunflower or Brassica L. seed which is obtainable by a process of electrostatic separation. The dry sunflower protein-rich composition may comprise a dry matter content of sunflower proteins ranging from 44 to 60, in weight %, and a dry matter content of Acid Detergent Lignin ranging from 2 to 5 in weight % in respect of the total weight of dry matter of said composition. The dry Brassica L. protein-rich composition may comprise a dry matter content of Brassica L. proteins ranging from 40 to 50, in weight %, and a content of Acid Detergent Lignin ranging from 1.5 to 4 in weight % in respect of the total weight of dry matter of said composition.

### FIELD OF THE INVENTION

The invention relates to the field of protein fractionation of an oilseed meal and in particular a Brassica L. and/or a sunflower seed meal.

### PRIOR ART

Oils seed meals are prepared from an oilseed in which the oilseed has been ground and crushed to form a meal. Oil may have been extracted either partially or totally from the oilseed meal to form what is known in the art as a «pressed cake» or a (partially) «defatted meal». To obtain a defatted meal, solvent can be used for example, hydrophobic solvents such as pentane, hexane and/or other refrigerants such as iodotrifluoromethane (ITFM) and R134a (1,1,1,2-tetrafluoroethane), to remove or reduce residual oil from the seedcake. When such organic solvents are used the oil content remaining in the pressed cake is residual (e.g. ranging from 0.1 to 4 wt % by total weight of the pressed cake).

Oilseed meals have interesting feeding properties for animals, however the animal feed currently available have a protein level which is ranging from 27% to 40% w/w. A recognised target for animal feed purpose is to reach at least 50 wt % of proteins. Another desirable target is a fraction with a low content of fibers.

Aquaculture production has undergone remarkable growth during the past few decades, and it will continue to rise in the coming years to meet higher demand for safe, healthy and convenient seafood products. The future growth of the animal feed industry, comprising aquafeeds, faces great challenges, since traditional sources of high quality feed ingredients will not be able to meet the rising demands. Novel ingredients, serving as sustainable sources of protein and oils are needed.

Two main processes can be implemented to process oilseed meals in order to increase the percentage of proteins: wet extraction and dry extraction (fractionation). A wet extraction process uses a solvent, such as water, to extract the proteins from a (usually defatted) oilseed meal via solubilisation, separation and concentration. Such processes are wasteful in energy and in solvent (water), but are the ones most commonly used for obtaining extracts with high levels of proteins.

Dry fractionation is carried out by separation of finely ground dry powders, or flours, originating from, at least partially, defatted oilseed meals coming from dehulled or non dehulled seed. One method to separate fibre-containing oilseeds into fractions with different fibre content is the use of electrostatic separation carried out by a conductive rotating drum separator with a drum tangential speed within the range of 1.5 to 3 meter/second and a voltage within the range of 5 and 40 kilo Volt, such as disclosed in patent publication EP 1908 355. Another method known to separate unburned carbon from fly ash, but which may also be used to separate flour from bran, is the use of triboseparation carried out with a belt-type electrostatic separator, such as described in patent publication WO2012/031080. The physical characteristics that are used in the dry process are the differences of electrostatic charge of grounded flour particles according to their composition. Grinded oilseed meals are constituted of mixed particles made of a combination of materials and comprise particles richer in protein and particles richer in bran and fibers. The smaller the particles are, the purer each particle is. Depending upon its composition, each particle which is submitted to a friction becomes charged and particles having similar characteristics of charge and mass can be separated by the application of an electromagnetic field. This principle has now been successfully applied to a belt separator system. According to such a system a mixture of particles is loaded onto a belt between electrodes where it is subjected to an electric field generated by the electrodes. The net result is that the positively charged particles subjected to the electric field move towards the negative electrode and the negatively charged particles move towards the positive electrode. The counter-current action of the moving belt segments sweep the electrodes in opposite directions and transport the constituents of the particle mixture to their respective discharge points on either end of the separator. Ultimately, each particle is transferred toward one end of the system by the counter-current moving belt that produces a certain degree of separation of the particle mixture. However due to the complexity of their constituents and their size, organic particles do not act as mineral particles and are difficult to dissociate and concentrate according to this method. For example vertical type parallel electrostatic separators are rapidly covered by a layer of charged powder, and the efficacy of the filter capacity of the electrostatic separator is therefore reduced.

It has now been found that the process according to the invention, which uses tribo-separation (or tribo-electrostatic separation), allows to obtain a composition which originates from oilseed and which is either high in proteins and low in fibres and/or low in proteins and high in fibres when compared to the respective relative amount of proteins and fibres contained in the starting material, such as an oilseed meal.

A particular embodiment of the invention is therefore a protein-rich fraction from oilseed meal which is obtained, or can be obtained, by a process of electrostatic separation, said process comprising the following steps:
a) providing a grinded particles powder of an oilseed meal, said oilseed meal having a D₅₀ ranging from 400 μm to 10 μm and a moisture content ranging from 2% to 15% in weight by total weight of said powder, to a device for electrostatic separation, said device comprising:
   a feed port,
   at least two parallel, spaced, electrodes each positioned horizontally facing one another, one of said electrode being a top electrode and the other being a bottom electrode, and an electrode gap being defined as the space between said two electrodes,
   a belt traveling in a generally horizontal direction, said belt being positioned, at least partially, within said gap between said spaced electrodes, said belt forming a continuous longitudinal loop having two extremities, and having two opposite traveling belt portions which are moving in opposite directions for transporting particles of said powder to an extremity of said belt,
   a first collecting container in fluid communication with one of the extremity of said belt to collect the particles dropping from said belt at that one extremity;
b) applying an electrical field between said electrodes by applying to said electrodes a difference of potential of 2 to 8 kV;
c) driving said belt at a speed ranging from 15 to 25 m/s, preferably 15 to 20 m/s;
d) feeding said grinded particle powder to said travelling belt via said feed port within said continuous longitudinal loop; and
e) recovering said protein fraction from said first collecting container;

wherein said oilseed meal is a sunflower seed meal or Brassica L. seed meal, preferably sunflower meal.

Brassica L. preferably includes Brassica napus L., Brassica napus var. napus (rapeseed or canola), Brassica carinata, Brassica oleracea, Brassica rapa, Brassica nigra, more preferably Brassica napus L., Brassica napus var. napus, Brassica carinata, most preferably Brassica napus var. napus.

The term sunflower refers to Helianthus annuus.

The expression “protein-rich” refers, of course, to the fact that the protein content of the composition, or fraction, according to the invention is higher than the protein content of the original oilseed meal.

The expression “dry matter” is used in the usual way to describe the part of the composition, fraction or substance that would remain if all its water content was removed.

An oilseed meal is the result of an extraction of oil from the seed. Any known extraction processes is encompassed by this term, such as the use of mechanical pressure, which can be combined with either an organic (chemical) extractant (e.g. hexane) and/or an increased temperature. According to a variant of the invention an organic extractant can be used, although it is encompassed that no organic (chemical) extractant is utilised in the process, especially when the protein-rich composition is for human consumption. It is preferred that the oilseed meal, or “cake”, to be fractionated is defatted, that is, contains very little oil (e.g. less than 5% w/w, preferably less than 2%, by total weight of the meal).

It is also preferred for the oil seed meal to be made from dehulled seed.

Advantageously the oilseed meal to be used as a starting material has a protein content (w/w) of at least 20%, in particular at least 30%, by total weight of the oilseed meal.

When using a sunflower-seed meal it is preferred to use a meal having a protein content (w/w) ranging from 28.0% to 40.0%, in particular 34.0% to 39.0%, for example 37.3%. When using a Brassica L. meal, it is preferred to use a meal having a protein content ranging from 25.0%. to 35.0%, in particular 31.0% to 33.0%, for example 32.5%.

The protein-rich fraction according to the invention is advantageously obtained by electrostatic separation, also known as “tribo-separation”. This process is applied to dry particles of the oilseed meal as a starting material. The term “dry” when applied to the fraction or the composition of the invention refers to a moisture content which is usually inferior to 15% (w/w), more particularly inferior to 10%. Thus the oilseed meal is usually grinded. The oilseed meal can be grinded using a classifier mill, jet mill, fine impact mill, pin mill or an air classifier mill. The average size of the particle's powder or the size distribution of the particles may vary. Advantageously, the grinded particles have a D₅₀ being less than, or equal to, 50 μm, preferably less than, or equal to, 25 μm According to a preferred embodiment the size distribution of the particles used presents a D₅₀ which may range from 10 μm to 300 μm, preferably from 10 μm to 200 μm. It is preferred to use a D₅₀ ranging from 10 μm to 100 μm, preferably from 10 μm to 50 μm and most preferably from 20 μm to 30 μm. According to another preferred embodiment, the size distribution of the particles used presents a D₉₀ which may range 500 μm to 50 μm, preferably from 300 μm to 60 μm, more preferably from 150 μm to 50 μm. Using a combination of the following D₅₀ and D₉₀ values from 20 μm to 30 μm and from 60 μm to 300 μm, respectively, provides particularly good results for protein fractionation of Brassica L. meal. Using a combination of the following D₅₀ and D₉₀ values from 30 μm to 70 μm and from 70 μm to 150 μm respectively provides particularly good results for protein fractionation of a sunflower meal.

The device used to carry out the electrostatic separation comprises at least one feed port which is usually positioned above the belt/electrode arrangement, preferably vertically. The feed port of the device is advantageously internally configured to increase the electrostatic charges of the oilseed meal particles falling through the port. For example, the feeding port can be of a sufficient length and include projections, mesh or corrugations on its internal surface, or volume, to provide such an electrostatic charging effect. If the fraction of interest is the protein-rich fraction, then the feeding port is preferably positioned close or closer to the collecting device for the protein-rich fraction and if the fraction of interest is the fibre-rich fraction then the feeding port is preferably positioned close or closer to the collective device for said fibre-rich fraction, in order to improve the mass yield of said fraction of interest in protein or fibre respectively.

The distance, or space, between the two electrodes, the “electrode gap”, may vary from 0.5 cm to 2 cm. Preferably, this distance may range from 1.1 to 1.3 cm, and particularly may be 1.2 cm. The top electrode may present a positive polarity and said bottom electrode a negative polarity, or vice versa.

The difference of potential applied to the electrodes may be in a range from 2 to 8 kV, preferably from 5 to 7 kV, and preferably around 6 kV.

The belt is traveling in a generally horizontal direction and most of the belt's surface, in use, is moving according to a horizontal direction. The belt is being positioned, at least partially, in between the electrodes' gap. The dimension of the belt/electrodes arrangement can be variable depending upon, inter alia, the quantity of oilseed meal particles to be processed. The skilled person would know how to scale up or down such features. The belt material is made of an elastomeric material of the type generally used for this type of device. The belt can advantageously be of an opened grid construction or have a mesh configuration such as the ones shown in patent publication WO 98/31469.

The speed of the belt conveying the particles may conveniently vary, although in order to carry out a particularly effective separation a high speed is preferred. Such a speed should be at least of 3 m/s, preferably at least 15 m/s and more preferably 20 m/s. Using a speed ranging from 18 m/s to 21 m/s provides particularly good results.

At the extremity of the belt, the protein-rich particles which are positively charged and which have been conveyed by the belt's portion closest to the negatively charged electrode, reach the point where the belt leave the electrode vicinity and fall or drop from the belt. A first container (24) positioned at this point collects the falling particles which then forms a protein-rich fraction.

The fractioning, or separating, process can be carried out more than once. According to an embodiment of the invention steps a) to e) are carried out on a protein fraction recovered from step e), at least once. Such a process would provide a fraction which would know as a second “pass”.

The expression “protein-rich fraction” within the meaning of the invention is a quantity of powder originating from oilseed, in particular from an oilseed meal, and obtained according to a fractionating separation process. In such a process, the starting material is separated into fractions, which have compositions that vary according to a gradient. Fractions are collected based on differences in a specific property of the individual components, in this case, electrostatic charges.

The average increase in protein content, in weight, that can be obtained is at least superior to 4%, generally superior to 5%, preferably superior to 9% and even up to 15%, or more (e.g. 21%).

Protein Content

Preferably, the sunflower protein-rich fraction, or composition, according to the invention has a protein content (w/w dry matter) which ranges from 44% to 60%, preferably from 48% to 60%, more preferably from 50% to 60%, by total weight of dry matter of said fraction or composition. These values are measured according to French Standard NF EN Iso 16634 (2008).

Preferably, the Brassica L. protein-rich fraction, or composition, according to the invention has a protein content (w/w dry matter) as measured according to the standard which ranges from 40% to 50%, preferably from 42% to 50%, more preferably from 45% to 50%, by total weight of dry matter of said fraction or composition. These values are measured according to French Standard NF EN Iso 16634 (2008).

Acid Detergent Lignin (ADL) Content

Preferably, the sunflower protein-rich fraction, or composition, according to the invention has an ADL content (w/w dry matter) which ranges from 0.5% to 5%, preferably from 2% to 5%, by total weight of dry matter of said fraction or composition. These values are measured according to French Standard NF V18-122 (2013).

Preferably, the Brassica L. protein-rich fraction, or composition, according to the invention has an ADL content (w/w dry matter) which ranges from 1.5% to 4%, preferably from 2% to 3.5%, by total weight of dry matter of said fraction or composition. These values are measured according to French Standard NF V18-122 (2013).

Cellulose Content

Preferably, the sunflower protein-rich fraction, or composition, according to the invention has a cellulose content (w/w dry matter) which ranges from 4% to 15%, preferably from 4% to 10%, by total weight of dry matter of said fraction or composition. These values are measured according to French Standard NF V03-040 (1993).

Preferably, the Brassica L. protein-rich fraction, or composition, according to the invention has a cellulose content (w/w dry matter) which ranges from 6% to 11%, preferably from 6% to 9%, by total weight of dry matter of said fraction or composition. These values are measured according to French Standard NF V03-040 (1993).

Mineral (Inorganic) Materials

Preferably, the sunflower protein-rich fraction, or composition, according to the invention has a mineral materials' content (w/w dry matter) which ranges from 6.5% to 10%, preferably from 6.5% to 9%, more preferably from 6.5% to 8%, by total weight of dry matter of said fraction or composition. These values are measured according to French Standard NF V18-101 (1977).

Preferably, the Brassica L. protein-rich fraction, or composition, according to the invention has a mineral materials' content (w/w dry matter) which ranges from 5.5% to 8%, preferably 5.5% to 7%, by total weight of dry matter of said fraction or composition. These values are measured according to French Standard NF V18-101 (1977).

Neutral Detergent Fibre (NDF)

Preferably, the sunflower protein-rich fraction, or composition, according to the invention has a neutral detergent fibre content (w/w dry matter) which ranges from 8% to 38%, preferably from 16% to 38%, more preferably 16% to 25%, by total weight of dry matter of said fraction or composition. These values are measured according to French Standard NF V18-122 (2013).

Preferably, the Brassica L. protein-rich fraction, or composition, according to the invention has a neutral detergent fibre content (w/w dry matter) which ranges from 20% to 38%, preferably 22% to 30%, by total weight of dry matter of said fraction or composition. These values are measured according to French Standard NF V18-122 (2013).

Acid Detergent Fibre (ADF)

Preferably, the sunflower protein-rich fraction, or composition, according to the invention has an acid detergent fibre content (w/w dry matter) which ranges from 5% to 20%, preferably from 8% to 20%, more preferably from 8% to 14%, by total weight of dry matter of said fraction or composition. These values are measured according to French Standard NF V18-122 (2013).

Preferably, the Brassica L. protein-rich fraction, or composition, according to the invention has an acid detergent fibre content (w/w dry matter) which ranges from 10% to 20%, preferably from 12% to 15%, by total weight of dry matter of said fraction or composition. These values are measured according to French Standard NF V18-122 (2013).

Particle Size Distribution

Preferably, the sunflower protein-rich fraction, or composition, according to the invention is a powder made of particles. Advantageously the size distribution of the particles presents a D₅₀ which may range from 10 μm to 300 μm, preferably from 10 μm to 200 μm. More preferably the D₅₀ ranges from 30 μm to 70 μm It is further preferred that the powder also presents a D₉₀ ranging from 50 μm to 500 μm, preferably 50 μm to 300 μm, more preferably 50 μm to 150 μm. Using a combination of the following D₅₀ and D₉₀ values 30 μm to 70 μm and 50 μm to 150 μm respectively provides particularly good results. These values are measured with Malvern equipment by laser diffraction using dry dispersion method (i.e. the particles are dispersed in air).

Preferably, the Brassica L. protein-rich fraction, or composition, according to the invention is a powder made of particles. Advantageously the size distribution of the particles present a D₅₀ which may range from 10 μm to 300 μm, preferably from 10 μm to 200 μm. More preferably the D₅₀ ranges from 30 μm to 70 μm. It is further preferred that the powder also presents a D₉₀ ranging from 50 μm to 500 μm, preferably 50 μm to 300 μm, more preferably 50 μm to 100 μm. Using a combination of the following D₅₀ and D₉₀ values 30 μm to 70 μm and 50 μm to 100 μm respectively provides particularly good results. These values are measured with Malvern equipment by laser diffraction using dry dispersion method (i.e. the particles are dispersed in air).

Moisture Content

Preferably, the sunflower protein-rich fraction, or composition, according to the invention has a moisture content (w/w) which ranges from 2.5% to 12%, by total weight of said fraction. These values are measured according to French Standard NF V18-109 (October 2011).

Preferably, the Brassica L. protein-rich fraction, or composition, according to the invention has a moisture content (w/w) which ranges from 2.5% to 12% by total weight of said fraction. These values are measured according to French Standard NF V18-109 (October 2011).

Fat Content

Preferably, the sunflower protein-rich fraction, or composition, according to the invention has a fat content (w/w dry matter) which ranges from 1% to 6% by total weight of dry matter of said fraction or composition. These values are measured according to European Standard CEE 98/64 (1998).

Preferably, the Brassica L. protein-rich fraction, or composition, according to the invention has a fat content (w/w dry matter) which ranges from 1% to 6% by total weight of dry matter of said fraction or composition. These values are measured according to European Standard CEE 98/64 (1998).

As a particularly preferred embodiment of the invention the sunflower protein-rich fraction, or composition, has both the protein content and the lignin content mentioned above.

As another particular preferred embodiment of the invention the sunflower protein-rich fraction, or composition, has both a protein content (w/w dry matter) ranging from 44% to 60% and a lignin content (w/w dry matter) ranging from 2% to 5%, by total weight of dry matter of said fraction or composition. Preferably, the protein content (w/w dry matter) ranges from 50% to 60% and the lignin content (w/w dry matter) ranges from 3% to 4%, by total weight of dry matter of said fraction or composition.

As another particular preferred embodiment of the invention, the sunflower protein-rich fraction, or composition, has a protein content (w/w dry matter) ranging from 44% to 60%, a lignin content (w/w dry matter) ranging from 2% to 5%, a cellulose content (w/w dry matter) ranging from 4% to 15%, a mineral materials content (w/w dry matter) ranging from 6.5% to 9%, a neutral detergent fibre content (w/w dry matter) ranging from 16% to 38%, an acid detergent fibre content (w/w dry matter) ranging from 8% to 20%, a D₅₀ particle size distribution ranging from 10 μm to 300 μm, a moisture content (w/w) ranging from 2.5% to 12% and a fat content (w/w dry matter) ranging from 1% to 6%, by total weight of dry matter of said fraction or composition.

As another particular preferred embodiment of the invention the sunflower protein-rich fraction, or composition, has a protein content (w/w dry matter) ranging from 50% to 60%, a lignin content (w/w dry matter) ranging from 3% to 4%, a cellulose content (w/w dry matter) ranging from 4% to 10%, a mineral materials content (w/w dry matter) ranging from 6.5% to 8%, a neutral detergent fibre content (w/w dry matter) ranging from 16% to 25%, an acid detergent fibre content (w/w dry matter) ranging from 8% to 14%, a D₅₀ particle size distribution ranging from 30 μm to 100 μm, preferably from 30 μm to 70 μm, a moisture content (w/w) ranging from 2.5% to 12% and a fat content (w/w dry matter) ranging from 1% to 6%, by total weight of dry matter of said fraction or composition.

As another particular preferred embodiment of the invention the sunflower protein-rich fraction, or composition, has a protein content (w/w dry matter) ranging from 50% to 60%, a cellulose content (w/w dry matter) ranging from 4% to 10%, a mineral materials content (w/w dry matter) ranging from 6.5% to 10%, a neutral detergent fibre content (w/w dry matter) ranging from 8% to 13%, an acid detergent fibre content (w/w dry matter) ranging from 0.5% to 10%, a D₅₀ particle size distribution ranging from 30 μm to 100 μm, a moisture content (w/w) ranging from 4% to 12% and a fat content (w/w dry matter) ranging from 1% to 3%, by total weight of dry matter of said fraction or composition.

As a particularly preferred embodiment of the invention, the Brassica L. protein-rich fraction, or composition, has both the protein content and the lignin content mentioned above.

As another particular preferred embodiment of the invention the Brassica L. protein-rich fraction, or composition, has both a protein content (w/w dry matter) ranging from 40% to 50% and a lignin content (w/w dry matter) ranging from 1.5% to 4%, by total weight of dry matter of said fraction or composition. Preferably, the protein content (w/w dry matter) ranges from 45% to 50% and the lignin content (w/w dry matter) ranges from 2% to 3.5%, by total weight of dry matter of said fraction or composition.

As another particular preferred embodiment of the invention the Brassica L. protein-rich fraction, or composition, has a protein content (w/w dry matter) ranging from 40% to 50%, a lignin content (w/w dry matter) ranging from 1.5% to 4%, a cellulose content (w/w dry matter) ranging from 6% to 11%, a mineral materials content (w/w dry matter) ranging from 5.5% to 8%, a neutral detergent fibre content (w/w dry matter) ranging from 20% to 38%, an acid detergent fibre content (w/w dry matter) ranging from 10% to 20%, a D₅₀ particle size distribution ranging from 10 μm to 300 μm, a moisture content (w/w) ranging from 2.5% to 12% and a fat content (w/w dry matter) ranging from 1.5% to 6%, by total weight of dry matter of said fraction or composition.

As another particular preferred embodiment of the invention the Brassica L. protein-rich fraction, or composition, has a protein content (w/w dry matter) ranging from 45% to 50%, a lignin content (w/w dry matter) ranging from 2% to 3.5%, a cellulose content (w/w dry matter) ranging from 6% to 9%, a mineral materials content (w/w dry matter) ranging from 5.5% to 7%, a neutral detergent fibre content (w/w dry matter) ranging from 20% to 30%, an acid detergent fibre content (w/w dry matter) ranging from 12% to 15%, an D₅₀ particle size distribution ranging from 30 μm to 70 μm, a moisture content (w/w) ranging from 2.5% to 12% and a fat content (w/w dry matter) ranging from 1.5% to 6%, by total weight of dry matter of said fraction or composition.

Fibre-Rich Fraction

As it can be easily understood, during the tribo-separation, protein-low particles are separated from protein-rich particles. These protein-low (fibre-rich particles) can also be recovered. Indeed, as they are charged negatively, they will be moving and be conveyed to the opposite extremity of the belt by the electrode/belt separator. A second collecting container in fluid communication with said opposite extremity of the separating belt can be provided to collect the particles' powder dropping or falling at that opposite end. The collected particles will form a fibre-rich fraction. Such a fibre-rich fraction, from a sunflower seed of a Brassica L. seed meal, is also an object of the invention.

Protein Content

Preferably, the sunflower fibre-rich fraction, or composition, according to the invention has a protein content (w/w dry matter) which ranges from 20% to 35%, preferably 25% to 32% by total weight of dry matter of said fraction or composition. These values are measured according to French Standard NF EN Iso 16634 (2008).

Preferably, the Brassica L. fibre-rich fraction, or composition, according to the invention has a protein content (w/w dry matter) which ranges from 20% to 35%, preferably 25% to 32%, by total weight of dry matter of said fraction or composition. These values are measured according to French Standard NF EN Iso 16634 (2008).

Acid Detergent Lignin Content (ADL)

Preferably, the sunflower fibre-rich fraction, or composition, according to the invention has an ADL content (w/w dry matter) which ranges from 5% to 15%. These values are measured according to French Standard NF V18-122 (2013).

Preferably, the Brassica L. fibre-rich fraction, or composition, according to the invention has an ADL content (w/w dry matter) which ranges from 10% to 20% by total weight of dry matter of said fraction or composition. These values are measured according to French Standard NF V18-122 (2008).

Cellulose Content

Preferably, the sunflower fibre-rich fraction, or composition, according to the invention has a cellulose content (w/w dry matter) which ranges from 25% to 35% by total weight of dry matter of said fraction or composition. These values are measured according to French Standard NF V03-040 (1993).

Preferably, the Brassica L. fibre-rich fraction, or composition, according to the invention has a cellulose content (w/w dry matter) which ranges from 15% to 25% by total weight of dry matter of said fraction or composition. These values are measured according to French Standard NF V03-040 (1993).

Mineral Materials

Preferably, the sunflower fibre-rich fraction, or composition, according to the invention has a mineral materials' content (w/w dry matter) which ranges from 4% to 10% by total weight of dry matter of said fraction or composition. These values are measured according to French Standard NF V18-101 (2013).

Preferably, the Brassica L. fibre-rich fraction, or composition, according to the invention has a mineral materials' content (w/w dry matter) which ranges from 4% to 10% by total weight of dry matter of said fraction or composition. These values are measured according to French Standard NF V18-101 (2013).

Neutral Detergent Fibre (NDF)

Preferably, the sunflower fibre-rich fraction, or composition, according to the invention has a neutral detergent fibre content (w/w dry matter) which ranges from 40% to 55%, preferably from 45% to 55%, by total weight of dry matter of said fraction or composition. These values are measured according to French Standard NF V18-122 (2013).

Preferably, the Brassica L. fibre-rich fraction, or composition, according to the invention has a neutral detergent fibre content (w/w dry matter) which ranges from 40% to 55%, preferably from 45% to 55%, by total weight of dry matter of said fraction or composition. These values are measured according to French Standard NF V18-122 (2013).

Acid Detergent Fibre (ADF)

Preferably, the sunflower fibre-rich fraction, or composition, according to the invention has an acid detergent fibre content (w/w dry matter) which ranges from 20% to 35%, preferably from 25% to 35%, by total weight of dry matter of said fraction or composition. These values are measured according to French Standard NF V18-122 (2013).

Preferably, the Brassica L. fibre-rich fraction, or composition, according to the invention has an acid detergent fibre content (w/w dry matter) which ranges from 20% to 35%, preferably from 25% to 35%, by total weight of dry matter of said fraction or composition. These values are measured according to French Standard NF V18-122 (2013).

Particle Size Distribution

Preferably, the sunflower fibre-rich fraction, or composition, according to the invention is a powder made of particles. Advantageously the size distribution of the particles presents a D₅₀ which may range from 10 μm to 400 μm, preferably from 10 μm to 200 μm. Preferably the D₅₀ ranges from 30 μm to 70 μm. It is further preferred that the powder also presents a D₉₀ ranging from 50 μm to 500 μm, preferably 50 μm to 300 μm, more preferably 50 μm to 150 μm. Using a combination of the following D₅₀ and D₉₀ values ranging from 30 μm to 70 μm and 50 μm to 150 μm, respectively, provides particularly good results. These values are measured with Malvern equipment by laser diffraction using dry dispersion method (i.e. the particles are dispersed in air).

Preferably, the Brassica L. fibre-rich fraction, or composition, according to the invention is a powder made of particles. Advantageously the size distribution of the particles present a D₅₀ which may range from 10 μm to 400 μm, preferably from 10 μm to 200 μm. Preferably, the D₅₀ ranges from 30 μm to 70 μm. It is further preferred that the powder also presents a D₉₀ ranging from 50 μm to 500 μm, preferably 50 μm to 300 μm, more preferably 50 μm to 100 μm. Using a combination of the following D₅₀ and D₉₀ values ranging from 30 μm to 70 μm and 50 μm to 100 μm, respectively, provides particularly good results. These values are measured with Malvern equipment by laser diffraction using dry dispersion method (i.e. the particles are dispersed in air).

Moisture Content

Preferably, the sunflower fibre-rich, or composition, according to the invention has a moisture content (w/w) which ranges from 2.5% to 12% These values are measured according to French Standard NF V18-109 (October 2011).

Preferably, the Brassica L. fibre-rich, or composition, according to the invention has moisture content (w/w) which ranges from 2.5% to 12%. These values are measured according to French Standard NF V18-109 (October 2011).

Fat Content

Preferably, the sunflower fibre-rich, or composition, according to the invention has a fat content (w/w dry matter) which ranges from 1% to 6%. These values are measured according to European Standard CEE 98/64 (2011).

Preferably, the Brassica L. fibre-rich, or composition, according to the invention has a fat content (w/w dry matter) which ranges from 1.5% to 6%. These values are measured according to European Standard CEE 98/64 (2011).

As a particularly preferred embodiment of the invention, the sunflower fibre-rich fraction, or composition, has the cellulose content, the neutral detergent fibre content and the acid detergent fibre content mentioned above.

As another particular preferred embodiment of the invention the sunflower fibre-rich fraction, or composition, has the cellulose content (w/w dry matter) ranging from 25% to 35%, the neutral detergent fibre content (w/w dry matter) ranging from 40% to 55% and the acid detergent fibre content (w/w dry matter) ranging from 20% to 35%, by total weight of dry matter of said fraction or composition, preferably the cellulose content (w/w dry matter) ranging from 25% to 35%, the neutral detergent fibre content (w/w dry matter) ranging from 45% to 55% and the acid detergent fibre content (w/w dry matter) ranging from 25% to 35%, by total weight of dry matter of said fraction or composition.

As another particular preferred embodiment of the invention the sunflower fibre-rich fraction, or composition, has protein content protein content (w/w dry matter) ranging from 20% to 35%, lignin content (w/w dry matter) ranging from 5% to 15%, cellulose content (w/w dry matter) ranging from 25% to 35%, mineral materials content (w/w dry matter) ranging from 4% to 10%, neutral detergent fibre content (w/w dry matter) ranging from 40% to 55%, acid detergent fibre content (w/w dry matter) ranging from 20% to 35%, D₅₀ particle size distribution ranging from 10 μm to 300 μm, moisture content (w/w) ranging from 2.5% to 12% and fat content (w/w dry matter) ranging from 1% to 6%, by total weight of dry matter of said fraction or composition.

As another particular preferred embodiment of the invention the sunflower fibre-rich fraction, or composition, has protein content protein content (w/w dry matter) ranging from 20% to 32%, lignin content (w/w dry matter) ranging from 5% to 15%, cellulose content (w/w dry matter) ranging from 25% to 35%, mineral materials content (w/w dry matter) ranging from 4% to 10%, neutral detergent fibre content (w/w dry matter) ranging from 45% to 55%, acid detergent fibre content (w/w dry matter) ranging from 25% to 35%, D₅₀ particle size distribution ranging from 30 μm to 70 μm, moisture content (w/w) ranging from 2.5% to 12% and fat content (w/w dry matter) ranging from 1% to 6%, by total weight of dry matter of said fraction or composition.

As a particularly preferred embodiment of the invention, the Brassica L. fibre-rich fraction, or composition, has both the cellulose content, the neutral detergent fibre content and the acid detergent fibre content mentioned above.

As another particular preferred embodiment of the invention the Brassica L. fibre-rich fraction, or composition, has the cellulose content (w/w dry matter) ranging from 15% to 25%, the neutral detergent fibre content (w/w dry matter) ranging from 40% to 55% and the acid detergent fibre content (w/w dry matter) ranging from 20% to 35%, by total weight of dry matter of said fraction or composition, preferably the cellulose content (w/w dry matter) ranging from 15% to 25%, the neutral detergent fibre content (w/w dry matter) ranging from 45% to 55% and the acid detergent fibre content (w/w dry matter) ranging from 25% to 35%, by total weight of dry matter of said fraction or composition.

As another particular preferred embodiment of the invention the Brassica L. fibre-rich fraction, or composition, has protein content protein content (w/w dry matter) ranging from 20% to 35%, lignin content (w/w dry matter) ranging from 10% to 20%, cellulose content (w/w dry matter) ranging from 15% to 25%, mineral materials content (w/w dry matter) ranging from 4% to 10%, neutral detergent fibre content (w/w dry matter) ranging from 40% to 55%, acid detergent fibre content (w/w dry matter) ranging from 20% to 35%, D₅₀ particle size distribution ranging from 10 μm to 300 μm, moisture content (w/w) ranging from 2.5% to 12% and fat content (w/w dry matter) ranging from 1.5% to 6%, by total weight of dry matter of said fraction or composition.

As another particular preferred embodiment of the invention the Brassica L. fibre-rich fraction, or composition, has protein content protein content (w/w dry matter) ranging from 25% to 32%, lignin content (w/w dry matter) ranging from 10% to 20%, cellulose content (w/w dry matter) ranging from 15% to 25%, mineral materials content (w/w dry matter) ranging from 4% to 10%, neutral detergent fibre content (w/w dry matter) ranging from 45% to 55%, acid detergent fibre content (w/w dry matter) ranging from 25% to 35%, D₅₀ particle size distribution ranging from 30 μm to 70 μm, moisture content (w/w) ranging from 2.5% to 12% and fat content (w/w dry matter) ranging from 1.5% to 6%, by total weight of dry matter of said fraction or composition.

According to another embodiment of the invention, a composition according to the invention can further be obtained by mixing together protein-rich fractions which are obtained by going through the above described processing steps a) to e), a different number of time. For example, an amount of a protein rich fraction obtained by fractioning the oilseed powder directly obtained from the grinding of the meal only once (one-pass fraction), can be mixed with another amount of a fraction which have already been fractionated twice (two-pass fraction).

Method

Another object of the invention is a process for obtaining a protein-rich fraction from an oilseed meal, by electrostatic separation, said process comprising the following steps:
a) providing a grinded particles powder of an oilseed meal, said oilseed meal having a D₅₀ ranging from 10 μm to 400 μm and a moisture content ranging from 2% to 15% in weight by total weight of said powder, to a device for electrostatic separation, said device (1) comprising:
   a feed port (12),
   two parallel, spaced electrodes, (21 & 21′) each positioned horizontally facing one another, one of said electrode (21) being a top electrode and the other being a bottom electrode (21′), and an electrode gap being defined as the space between said two electrodes (21 & 21′),
   a belt (18) traveling in a generally horizontal direction, said belt being positioned, at least partially, within said gap between said spaced electrodes (21 & 21′), said belt (18) forming a continuous longitudinal loop having two extremities, and having two opposite traveling belt portions which are moving in opposite directions and are configured for transporting particles of said powder to an extremity of said belt (18),
   a first collecting container in fluid communication with one of the extremity of said belt (18) to collect the particles dropping from said belt at that one extremity;
b) applying an electrical field between said electrodes by applying to said electrode a difference of potential of 2 to 8 kV,
c) driving said belt at a speed of 15 to 25 m/s;
d) feeding said grinded particle powder to said belt via said feed port within said continuous longitudinal loop; and
e) recovering said protein fraction from said first collecting container;

wherein said oilseed meal is a sunflower seed meal or Brassica L. seed meal, preferably sunflower meal.

The different embodiments of the protein-rich fraction defined above in terms of a process apply to the process of the invention.

Uses

Another object of the invention is the use of any one of the composition and/or fraction above described, or a mixture thereof, as feed or a food or a dietary supplement or additive, for animal and/or human consumption.

Another object of the invention is also any foodstuff containing a composition or a fraction above described and its manufacture thereof. In a particular embodiment the animal feed is selected from the group of fish, poultry, pork (including piglet), ruminant such as cattle (in particular veal), sheep and goat, and rabbit feed. In another particular embodiment, the protein-rich fraction, as well as any foodstuff/feed containing it is used as, or in, a feed as well as any foodstuff containing them and their manufacture thereof for animals selected from the group consisting of fish, poultry, pork (including piglet) and ruminant. In another particular embodiment, the fibre-rich fraction as well as any foodstuff/feed containing it, is used as, or in, a feed for animal selected from the group consisting of ruminant and rabbit.

According to a preferred embodiment, the above-referred fish belongs to the family Salmonidae more preferably the subfamily Salmonidae, most preferably to the genus Oncorhynchus spp and in a particular embodiment to the species Oncorhynchus mykiss (rainbow trout) or Oncorhynchus tshawytscha (chinnok salmon), the genus Salmo spp and in a particular embodiment to the species Salmo salar (Atlantic salmon).

According to another preferred embodiment, the above-referred fish are marine fish like European seabass (Dicentrarchus labrax), Asian seabass (Lates calcarifer), Red sea bream (Pagrus major) and Gilt-head sea bream (Sparus aurata).

Another object of the invention is the use of any one of the composition and/or fraction above described, or a mixture thereof, for the manufacture of a feed or feedstuff containing them, for feeding an animal as described above.

Another object of the invention is a process for manufacturing a feed or feedstuff comprising a step of blending or mixing any one of the composition and/or fraction above described, or a mixture thereof, with an animal feed raw material, such as an oilseeds meal (such as sunflower, Brassica L. and canola), soybean meal and grains (such as wheat, barley and maize) or a mixture thereof.

Another object of the invention is the use of any one of the composition and/or fraction above described, or a mixture thereof, as a biofuel or bio material, e.g. building materials. In particular, the use of fractions or compositions which are fibre-rich are considered particularly suitable for this use.

Another object of the invention is the use of any one of the composition and/or fraction above described, or a mixture thereof, preferably a protein-rich fraction from a sunflower meal as defined above, as a feed ingredient for manufacturing an aquafeed product. In a particular embodiment, said a protein-rich fraction from a sunflower meal as defined above is used as a aquafeed ingredient for improving protein digestibility and/or fish performance and/or feed efficacy in a fish, preferably in a fish of the genus Oncorhynchus, more preferably in Oncorhynchus mykiss.

Other features and advantages of the present invention will appear more clearly upon reading the following detailed examples, made with reference to the annexed drawing, and provided as a non-limiting description.

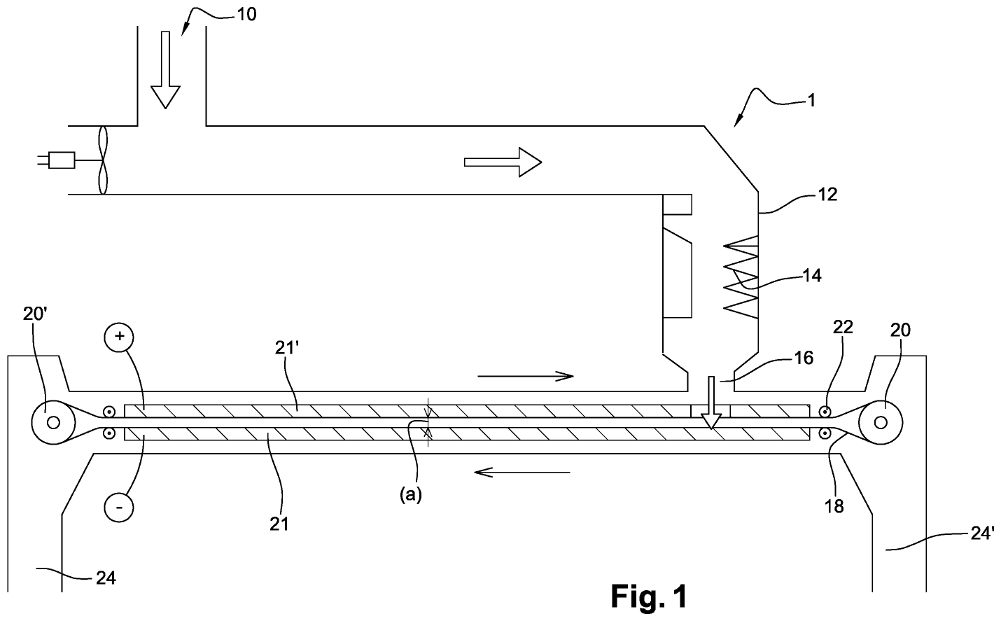

FIG. 1 is a top schematic view of a device for electrostatic separation which can be used in order to obtain a fraction or composition according to the invention.

### EXAMPLES

### Example 1—Sunflower

A protein-rich fraction and a fibre-rich fraction according to an embodiment of the invention are obtained from sunflower meal using the following process:

The sunflower seed meal used in this example is obtained from a defatted oilseed meal produced from dehulled seeds having a protein content of 35.5% w/w and a moisture content of about 4.6% by total weight of the meal.

The oil content of the meal is low (<2% w/w) as it is defatted using an organic solvent (i.e. hexane). The amount of protein is measured with the Dumas method calculated as N content×6.25. The amount of oil is measured with the method CEE 98/64.

The sunflower meal is grinded using a Hosokawa type ZPS grinding machine equipped with a classifier. The grinding parameters are adjusted to obtain the following particle size distribution at ambient temperature (about 17 C°):

D₅₀: 30.7 μm, and

D₉₀: 166.0 μm.

Particle size distributions are measured with Malvern equipment by laser diffraction using dry dispersion method (i.e. the particles are dispersed in air).

In order to produce a protein-rich and a protein-low fraction, the grinded sunflower meal is injected in a STET tribo-electrostatic belt separator schematically represented in FIG. 1.

The size of the separator device (1) used in the examples is 9.1 meters long, 1.7 meter wide, 3.2 meters high.

The particles are fed to the device (1) via the vertical feeding port (10) shown in FIG. 1. The sunflower meal powder is injected at the rate of 0.7 to 2.4 metric ton per hour. In the vertical feeder (12), each particle falling within said feeder first follows a random trajectory and hits the irregular walls (14) of the feeder (10) as well as the other particles thus gaining electro-static charges. Reaching the exit port (16) at the bottom of the vertical feeder (12), the particles are fed within the space defined by the loop created by the moving belt (18).

The conveyor belt (18) is driven by two driving wheels (20 and 20′) powered by synchronised engines and which are positioned at each end of the belt (18) and driving the belt (18) at a predetermined speed. The flexible belt (18) is wrapped around and rotates about the driving wheels (20 & 20′) to form a loop and is performing a continual revolutionary movement (a circular loop) around said two driving wheels (20 and 20′). The conveyor belt (18) is thus defining an internal space extending horizontally for about 7 to 9 meters in length. Two horizontal flat electrodes (21) and (21′) of opposite charges are positioned respectively above and below the belt portions, creating a magnetic field in the space between the two belt portions. The electrodes both extend horizontally for a substantial portion of the distance defined by the belt's length. The gap between both electrodes is about 1.20 cm. Four smaller (non-driving) wheels (22) are spaced from the driving wheels (20) and (20′) to guide the upper portion of the belt (18) beneath one electrode and the lower portion of the belt (18) above the other electrode. The potential difference applied is 6 kV.

Thus, the internal space created by the rotating pathway of the belt (18) has a narrow width (a) (less than 1.20 cm between the upper and lower belt portion as above mentioned). The belt (18) is moving at a high speed of about 20 m/s. The particles fed by the vertical feeder (12) to the electrode's gap are attracted by one of the electrode (20 & 20′) and repulsed by the other as well as conveyed by the belt (18).

The tribo-charged particles are attracted depending upon their specific charges by one of the electrodes (21) and (21′) and repulsed by the other. Particles of the same charges are attracted by one same electrode and carried along one of the belt (18) upper or lower portion up to one of the belt's end. Particles of opposite charges are attracted by the other electrode and carried along the opposite belt portion and are carried away to the other extremity of the belt. The belt surface is specifically corrugated or profiled in order to improve particles separation and clean the electrodes surfaces. More particularly the corrugations are specifically oriented in order to improve particle separation.

In the example presented the top electrode is charged positively. The upper portion of the belt loop, the one close to the positive electrode is going in one direction, the lower portion of the belt loop, the one close to the bottom negative electrode, is going to the opposite direction. Hence, negatively charged particles, rich in bran or fibres, are collected at one end of the loop belt, while positively charged particles, rich in proteins, are collected at the other end of the loop belt in collecting containers which are fluid communication with both the extremities of the belt (18).

The table below shows the characteristics of the sunflower seed meal (or feed material) and the 2 fractions (high and low protein) after a first pass.

TABLE I

| | | First Pass | First Pass Low |
|---|---|---|---|
| Type | Feed | High protein | protein |
| Particles distribution (D₅₀) (microns) | 30 | 30 | 50 |
| Humidity (%) | 4.6 | 4.3 | 4.3 |
| Protein content (% raw matter) | 37.3 | 45.2 | 27.4 |
| Fat/Lipid (% raw matter) | 1.7 | 1.6 | 1.7 |
| Cellulose (% raw matter) | 20.6 | 13.5 | 29.9 |
| Mineral Materials (% raw matter) | / | 7.2 | 5.8 |
| Neutral Detergent Fiber (% raw | / | 32.21 | 55.6 |
| matter) | | | |
| Acid Detergent Fiber (% raw matter) | / | 15.08 | 31.8 |
| Acid Detergent Lignin (% raw matter) | / | 4.12 | 10.8 |
| Average protein increase 1^{st} pass (%) | n/a | 21% | n/a |
| Average product yield 1^{st} pass (%) | n/a | 49.5% | 50.5% |

The humidity, or moisture content, is measured by gravimetry (loss of weight) after the sample being dried for 4 hours at 103° C. (standard NF ISO 6496 (October 2011). The protein content is assessed according to the Dumas method by measuring the nitrogen content of a charred sample (standard NF EN ISO 16634 (2008). The fat lipid content is measured by extraction using light petroleum (standard CEE98/64 (1998)). The cellulose content is assessed according to the Wendee method using gravimetric measurements before and after the sample is treated with various acids and alkaline materials (standard NF V03-040 (1993)). The amount of minerals is assessed using gravimetric measurements before and after a sample is mineralised at 550° C. according to the standard NF V18-101 (1977). Fibers and lignin contents are measured by using various detergents either neutral or acidic using standard methods (Standard NF V18-122 (2013)).

In order to increase further the protein content and reduce the proportion of cellulose or lignin (orADL) of the fraction high in proteins the resulting first pass high protein fraction was fed to the tribo-separating apparatus a second time to carry out a second fractionation.

The resulting composition (second pass high protein fraction), which is also part of the invention is shown in the following Table II.

TABLE II

| Analysis | Result | Unit |
|---|---|---|
| Solubility MAS KOH | 73 | G/L |
| MOISTURE-Dessic 4 h/103° C. NF ISO 6496 (10/2011) | 6.70 | % |
| PROTEIN CONTENT NF EN ISO 16634 (2008) | 48.9 | % |
| FAT CEE98/64 (light petroleum) 1998 | 1.8 | % |
| CELLULOSE-Wendee Gravimetric NF V 03-040 | 5.1 | % |
| MINERALS at 550° C. NF v 18-101 1977 | 7.6 | % |
| STARCH regulation CEE 152/2009 (Ewers specific | 4.4 | % |
| rotation) 2009 | | |
| TOTAL SUGARS LuffSchoorl R. CEE 152/2009 (ethanol) | 8.4 | % |
| NEUTRALDETERGENT FIBRE-Acid hydrolysis NF V 18- | 18.7 | % |
| 122 (2013) | | |
| ACID DETERGENT FIBRE-Acid Hydrolysis NF V 18-122 | 10.8 | % |
| (2013) | | |
| LIGNIN (ACID DETERGENT LIGNIN [ADL]) - Meth. Acid | 2.3 | % |
| hydrolysis NF V18-122 (2013) | | |
| PHOSPHORE - ICP microwave NF EN ISO 15621 (2012) | 1.500 | % |
| CALCIUM - ICP microwave NF EN ISO 15621 (2012) | 0.42 | % |
| POTASSIUM - ICP microwave NF EN ISO 15621 (2012) | 1.49 | % |
| SODIUM - ICP microwave NF EN ISO 15621 (2012) | 0.00 | % |
| TOTAL LYSINE - HPLC—NF EN ISO 13903 (2005) - react | 1.61 | % |
| ninhydrin/ detect. 570 nm. | | |
| METHIONINE - Method XP V 18-113 NF EN ISO 13903 | 0.86 | % |
| (2005) | | |
| ARGININ HPLC—NF EN ISO 13903 (2005) | 3.93 | % |
| TOTAL THREONIN - NF EN ISO 13903 (2005) | 1.85 | % |
| LEUCINE HPLC—NF EN ISO 13903 (2005) | 3.08 | % |
| ISOLEUCIN HPLC—NF EN ISO 13903 (2005) | 2.00 | % |
| VALIN HPLC—NF EN ISO 13903 (2005) | 2.29 | % |
| PHENYLALAMIN HPLC—NF EN ISO 13903 (2005) | 2.19 | % |
| TYROSIN HPLC—NF EN ISO 13903 (2005) | 0.00 | % |
| GLUTAMIC ACID HPLC—NF EN ISO 13903 (2005) | 9.37 | % |
| SERINE HPLC—NF EN ISO 13903 (2005) | 2.13 | % |
| HISTIDINE HPLC—NF EN ISO 13903 (2005) | 1.24 | % |
| ALANINE HPLC—NF EN ISO 13903 (2005) | 2.09 | % |
| ASPARTIC ACID HPLC—NF EN ISO 13903 (2005) | 4.54 | % |
| GLYCIN HPLC—NF EN ISO 13903 (2005) | 3 | % |
| PROLINE HPLC—NF EN ISO 13903 (2005) | 2 | % |
| GLUCOSINOLATES - dil. methanol - Internal Enzymatic | 0.00 | Mic |
| method ISO 9167 - HPLC (2013) | | Mol/g |
| C12.0 - CHROMATOGRAPHY NF EN ISO 5508/5509 (2011) | <0.100 pct | % |
| C14.0 - CHROMATOGRAPHY NF EN ISO 5508/5509 (2011) | <0.100 pct | % |
| C14.1 - CHROMATOGRAPHY NF EN ISO 5508/5509 (2011) | <0.100 pct | % |
| C15.0 - CHROMATOGRAPHY NF EN ISO 5508/5509 (2011) | <0.100 pct | % |
| C16.0 - CHROMATOGRAPHY NF EN ISO 5508/5509 (2011) | <0.100 pct | % |
| C16.1 - CHROMATOGRAPHY NF EN ISO 5508/5509 (2011) | <0.100 pct | % |
| C17.0 - CHROMATOGRAPHY NF EN ISO 5508/5509 (2011) | <0.100 pct | % |
| C17.1 - CHROMATOGRAPHY NF EN ISO 5508/5509 (2011) | <0.100 pct | % |
| C18.0 - CHROMATOGRAPHY NF EN ISO 5508/5509 (2011) | 3.4 | % |
| C18.1 - CHROMATOGRAPHY NF EN ISO 5508/5509 (2011) | 29.400 | % |
| C18.2 - CHROMATOGRAPHY NF EN ISO 5508/5509 (2011) | 59.500 | % |
| C18.3 - ALA CHROMATOGRAPHY NF EN ISO 5508/5509 | <0.100 | % |
| (2011) | | |
| C20.0 - CHROMATOGRAPHY NF EN ISO 5508/5509 (2011) | <0.100 pct | % |
| C20.1 - CHROMATOGRAPHY NF EN ISO 5508/5509 (2011) | <0.100 pct | % |
| C20.2 - CHROMATOGRAPHY (Omega 6) NF EN ISO | <0.100 pct | % |
| 5508/5509 (2011) | | |
| C20.4 - CHROMATOGRAPHY (Omega 6 ARA) NF EN ISO | <0.100 pct | % |
| 5508/5509 (2011) | | |
| C20.5 - CHROMATOGRAPHY (Omega 3 EPA) NF EN ISO | <0.1 | % |
| 5508/5509 (2011) | | |
| C22.0 - CHROMATOGRAPHY NF EN ISO 5508/5509 (2011) | <0.100 pct | % |
| C22.1 - CHROMATOGRAPHY NF EN ISO 5508/5509 (2011) | <0.100 pct | % |
| C22.4 - CHROMATOGRAPHY (Omega 6) NF EN ISO | <0.100 pct | % |
| 5508/5509 (2011) | | |
| C22.5 - CHROMATOGRAPHY (Omega 3 DPA) NF EN ISO | <0.100 pct | % |
| 5508/5509 (2011) | | |
| C22.6 - DHA CHROMATOGRAPHY (Omega 3 DHA) NF EN | <0.100 pct | % |
| ISO 5508/5509 (2011) | | |
| C24.0 - CHROMATOGRAPHY NF EN ISO 5508/5509 (2011) | <0.100 pct | % |
| ANTITRYPSIC FACTORS - XP V 18-202 AOCS Ba 12.75 | 1650.00 | TIU/G |
| (conformance) - 1991 - | | |
| % fatty Acids relative to C15:1 | <0.100 pct | % |
| C10:0 - Capric acid | <0.100 pct | % |
| C20.3 (n-3c) - Ac. Eicosatrinenoic | <0.100 pct | % |
| Compliance: YES | | |
| Pepsin Digestion - 24 h - Directive CEE 72/199 (1972) | 94.20 | % |
| MAS KOH | 35.900 | % |
| ERUCIC ACID | <0.100 pct | % |

“Solubility in KOH” measures the ratio of mass soluble protein in an aqueous solution of KOH of 0.035N in respect of the total mass of protein (e.g. Bipea FRANCE).

%: % weight by total weight of the mix.

The amounts of fatty acids is obtained (standard NF EN ISO 5508/5509 (2011)) by hexane extraction (at room T°), dissolution in iso-octane and transesterification of the sample using KOH. Neutralisation using sodium bisulphate is carried to prevent saponification. Esters are detected using GC/FID. Antitrypsic factors are measured by dosing the inhibition of added trypsin, using BAPA at 410 nm.

### Example 2—Canola

A protein-rich fraction and a fibre-rich fraction according to an embodiment of the invention are obtained from a rapeseed using the same method as described above.

The canola/rapeseed meal used in this example is obtained from a defatted oilseed meal from Brassica napus var. napus seed. The meat is produced from hulled seed having a protein content of 35.5% w/w and a moisture content of about 4.6% w/w.

The oil/fat content of the meal is low (<2% w/w) as it is defatted using an organic solvent (i.e. hexane). The amount of protein is measured with the Dumas method calculated as N content×6.25. The amount of oil is measured with the method CEE 98/64.

The meal is grinded using a Hosokawa type ZPS grinding machine equipped with a classifier. The grinding parameters are adjusted to obtain the following particle size distribution at ambient temperature (about 17 C°):

D₅₀: 24.6 μm

D₉₀: 88.8 μm.

The table below shows the characteristics of the feed material and the 2 fractions (high and low protein) after a first pass.

TABLE III

| | | First | First |
|---|---|---|---|
| | | Pass | Pass |
| | | High | Low |
| Type | Feed | protein | protein |
| Particle distribution (D₅₀) (microns) | 30 | | |
| Humidity (%) | 4.6 | 3.9 | 4.5 |
| Protein content (% raw matter) | 33.6 | 40.7 | 30 |
| Fat/Lipid (% raw matter) | n.d. | 2.2 | 2.1 |
| Cellulose (% raw matter) | 15.6 | 10.1 | 19.1 |
| Mineral Materials (% raw matter) | n.d. | 7.1 | 6.8 |
| Neutral Detergent Fiber | n.d. | 33.2 | 48.8 |
| (% raw matter) | | | |
| Acid Detergent Fiber (% raw matter) | n.d. | 15.4 | 30.0 |
| Acid Detergent Lignin (% raw matter) | n.d. | 3.6 | 13.2 |
| Average protein increase 1^{st} pass (%) | n/a | 21 | n/a |
| Average product yield 1^{st} pass (%) | n/a | 34.4 | 65.6 |

In order to demonstrate the reproducibility of the method, another canola/rapeseed meal sample was submitted to the triboseparation process and the detailed analysis of the content of high-protein first pass is shown below in Table IV.

TABLE IV

| Analysis | Result | Unit |
|---|---|---|
| Solubility MAS KOH | 54 | G/L |
| MOISTURE-Dessic 4 h/103° C. NF ISO 6496 (10/2011) | 5.20 | % |
| PROTEIN CONTENT NF EN ISO 16634 (2008) | 40.5 | % |
| FAT CEE98/64 (light petroleum) 1998 | 3.6 | % |
| CELLULOSE-Wendee Gravimetric NF V 03-040 | 7.2 | % |
| MINERALS at 550° C. NF v 18-101 1977 | 7.2 | % |
| STARCH regulation CEE 152/2009 (Ewers specific rotation) | 6.2 | % |
| 2009 | | |
| TOTAL SUGARS LuffSchoorl R. CEE 152/2009 (ethanol) | 10.7 | % |
| NEUTRALDETERGENT FIBRE - Acid hydrolysis NF V 18- | 19.3 | % |
| 122 (2013) | | |
| ACID DETERGENT FIBRE - Acid Hydrolysis NF V 18-122 | 10.7 | % |
| (2013) | | |
| LIGNIN (ACID DETERGENT LIGNIN [ADL]) - Meth. Acid | 2.0 | % |
| hydrolysis NF V18-122 (2013) | | |
| PHOSPHORE - ICP microwave NF EN ISO 15621 (2012) | 1.430 | % |
| CALCIUM - ICP microwave NF EN ISO 15621 (2012) | 0.58 | % |
| POTASSIUM - ICP microwave NF EN ISO 15621 (2012) | 1.22 | % |
| SODIUM - ICP microwave NF EN ISO 15621 (2012) | 0.00 | % |
| TOTAL LYSINE - HPLC—NF EN ISO 13903 (2005) - react | 2.15 | % |
| ninhydrin/detect. 570 nm. | | |
| METHIONINE - Method XP V 18-113 NF EN ISO 13903 (2005) | 0.81 | % |
| ARGININ HPLC—NF EN ISO 13903 (2005) | 2.45 | % |
| TOTAL THREONIN - NF EN ISO 13903 (2005) | 1.87 | % |
| LEUCINE HPLC—NF EN ISO 13903 (2005) | 2.95 | % |
| ISOLEUCIN HPLC—NF EN ISO 13903 (2005) | 1.66 | % |
| VALIN HPLC—NF EN ISO 13903 (2005) | 2.05 | % |
| PHENYLALAMIN HPLC—NF EN ISO 13903 (2005) | 1.66 | % |
| TYROSIN HPLC—NF EN ISO 13903 (2005) | 0.00 | % |
| GLUTAMIC ACID HPLC—NF EN ISO 13903 (2005) | 6.89 | % |
| SERINE HPLC—NF EN ISO 13903 (2005) | 1.83 | % |
| HISTIDINE HPLC—NF EN ISO 13903 (2005) | 1.16 | % |
| ALANINE HPLC—NF EN ISO 13903 (2005) | 1.89 | % |
| ASPARTIC ACID HPLC—NF EN ISO 13903 (2005) | 3.18 | % |
| GLYCIN HPLC—NF EN ISO 13903 (2005) | 2 | % |
| PROLINE HPLC—NE EN ISO 13903 (2005) | 3 | % |
| GLUCOSINOLATES- dil. methanol - Internal Enzymatic | 7.60 | Mic |
| method ISO 9167 - HPLC (2013) | | Mol/g |
| C12.0 CHROMATOGRAPHY NF EN ISO 5508/5509 (2011) | <0.100 pct | % |
| C14.0 CHROMATOGRAPHY- NF EN ISO 5508/5509 (2011) | <0.100 pct | % |
| C14.1 - CHROMATOGRAPHY NF EN ISO 5508/5509 (2011) | <0.100 pct | % |
| C15.0 - CHROMATOGRAPHY NF EN ISO 5508/5509 (2011) | <0.100 pct | % |
| C16.0 - CHROMATOGRAPHY NF EN ISO 5508/5509 (2011) | 6.800 | % |
| C16.1 - CHROMATOGRAPHY NF EN ISO 5508/5509 (2011) | 1.7 | % |
| C17.0 - CHROMATOGRAPHY NF EN ISO 5508/5509 (2011) | <0.100 pct | % |
| C17.1 - CHROMATOGRAPHY NF EN ISO 5508/5509 (2011) | <0.100 pct | % |
| C18.0 - CHROMATOGRAPHY NF EN ISO 5508/5509 (2011) | 1.5 | % |
| C18.1 - CHROMATOGRAPHY NF EN ISO 5508/5509 (2011) | 56.300 | % |
| C18.2 -CHROMATOGRAPHY NF EN ISO 5508/5509 (2011) | 25.400 | % |
| C18.3 - ALA CHROMATOGRAPHY NF EN ISO 5508/5509 | 6.500 | % |
| (2011) | | |
| C20.0 - CHROMATOGRAPHY NF EN ISO 5508/5509 (2011) | 0.9 | % |
| C20.1 - CHROMATOGRAPHY NF EN ISO 5508/5509 (2011) | 0.9 | % |
| C20.2 - CHROMATOGRAPHY (Omega 6) NF EN ISO | <0.100 pct | % |
| 5508/5509 (2011) | | |
| C20.4 - CHROMATOGRAPHY (Omega 6 ARA) NF EN ISO | <0.100 pct | % |
| 5508/5509 (2011) | | |
| C20.5 - CHROMATOGRAPHY (Omega 3 EPA) NF EN ISO | <0.1 | % |
| 5508/5509 (2011) | | |
| C22.0 - CHROMATOGRAPHY NF EN ISO 5508/5509 (2011) | <0.100 pct | % |
| C22.1 - CHROMATOGRAPHY NF EN ISO 5508/5509 (2011) | <0.100 pct | % |
| C22.4 - CHROMATOGRAPHY (Omega 6) NF EN ISO | <0.100 pct | % |
| 5508/5509 (2011) | | |
| C22.5 - CHROMATOGRAPHY (Omega 3 DPA) NF EN ISO | <0.100 pct | % |
| 5508/5509 (2011) | | |
| C22.6 - DHA CHROMATOGRAPHY (Omega 3 DHA) NF EN | <0.1 | % |
| ISO 5508/5509 (2011) | | |
| C24.0 - CHROMATOGRAPHY NF EN ISO 5508/5509 (2011) | <0.100 pct | % |
| ANTITRYPSIC FACTORS - XP V 18-202 AOCS Ba 12.75 | 713.00 | TIU/G |
| (conformance) - 1991 - | | |
| % fatty Acids relative to C15:1 | <0.100 pct | % |
| C10:0 - Capric acid | <0.100 pct | % |
| C20.3 (n-3c) - Ac. Eicosatrinenoic | | |
| Compliance: YES | <0.100 pct | % |
| Pepsin Digestion - 24 h - Directive CEE 72/199 (1972) | 91.20 | % |
| MAS KOH | 22000 | % |
| ERUCIC ACID | <0.100 pct | % |

Data from table III and IV were obtained according to the same methods than the ones described previously in reference with Tables I and II.

### Example 3—Efficacy of Sunflower Protein-Rich Fraction (SPRF) on Growth Performance, Nutrient Utilization and Digestibility of Rainbow Trout

In the present study, the effect of several plant protein sources (soy protein concentrate, sunflower protein-rich fraction according to the present invention) was assessed on the growth performance, whole body composition, nutrient retention and apparent digestibility in rainbow trout (Oncorhynchus mykiss).

3.1—Materials & Methods

3.1.a—Test Ingredients

SPRF1: sunflower protein-rich one-pass fraction “first pass” obtained according to Example 1 above from a sunflower meal which has been grinded to obtain a particle size distribution D₅₀ of 30 μm at ambient temperature before being injected in the STET tribo-electrostatic belt separator.
SPRF2: sunflower protein-rich one pass fraction “first pass” obtained according to Example 1 above from a sunflower meal which has been grinded to obtain a particle size distribution D₅₀ of 100 μm at ambient temperature before being injected in the STET tribo-electrostatic belt separator.
SPC: soy protein concentrate (Soycomil® P) obtained from ADM (The Netherlands).
SFM: solvent-extracted sunflower meal obtained from União Agricola do Norte U.C.R.L (Portugal), having an oil content from 1.8 to 2.1% (% dry matter) and a particle size of about 400 μm.

The various test ingredients were supplied in a ready to use powder form.

3.1.b—Experimental Diets

The trial comprised seven experimental diets as shown in Table V.

TABLE V
Formulation and proximate composition of the experimental diets.

| | Diets | | | | | | |
|---|---|---|---|---|---|---|---|
| | SOY | SOY | AQUASPRF1 | AQUASPRF1 | AQUASPRF2 | AQUASPRF2 | SUN |
| Ingredients, % | 15 | 30 | 15 | 30 | 15 | 30 | 15 |
| Fishmeal LT70 | 15.00 | 15.00 | 15.00 | 15.00 | 15.00 | 15.00 | 15.00 |
| Krill meal | 3.00 | 3.00 | 3.00 | 3.00 | 3.00 | 3.00 | 3.00 |
| SPC (Soycomil ® P) | 15.00 | 30.00 | 5.00 | 5.00 | 5.00 | 5.00 | 15.00 |
| SPRF1 (<30 μm) | | | 15.00 | 30.00 | | | |
| SPRF2 (<100 μm) | | | | | 15.00 | 30.00 | |
| Sunflower meal (SFM) | | | | | | | 15.00 |
| Pea protein concentrate | 1.50 | 1.50 | 1.50 | 1.50 | 1.50 | 1.50 | 1.50 |
| Wheat gluten | 3.50 | 3.25 | 4.85 | 4.90 | 4.85 | 4.90 | 6.45 |
| Corn gluten | 10.00 | 3.00 | 10.00 | 3.00 | 10.00 | 3.00 | 10.00 |
| Soybean meal 48 | 10.00 | | 5.00 | | 5.00 | | |
| Wheat meal | 10.20 | 11.95 | 8.90 | 5.70 | 8.90 | 5.70 | 5.00 |
| Faba beans (low tannins) | 11.00 | 11.00 | 11.00 | 11.00 | 11.00 | 11.00 | 8.00 |
| Fish oil | 10.20 | 10.50 | 10.50 | 10.14 | 10.50 | 10.14 | 10.23 |
| Rapeseed oil | 6.80 | 7.00 | 6.25 | 6.76 | 6.25 | 6.76 | 6.82 |
| Vitamin & Mineral Premix | 1.00 | 1.00 | 1.00 | 1.00 | 1.00 | 1.00 | 1.00 |
| Vitamin C (35%) | 0.03 | 0.03 | 0.03 | 0.03 | 0.03 | 0.03 | 0.03 |
| Vitamin E (50%) | 0.07 | 0.07 | 0.07 | 0.07 | 0.07 | 0.07 | 0.07 |
| Betaine HCl | 0.50 | 0.50 | 0.50 | 0.50 | 0.50 | 0.50 | 0.50 |
| Soy lecithin | 1.00 | 1.00 | 1.00 | 1.00 | 1.00 | 1.00 | 1.00 |
| Antioxidant | 0.20 | 0.20 | 0.20 | 0.20 | 0.20 | 0.20 | 0.20 |
| Sodium propionate | 0.10 | 0.10 | 0.10 | 0.10 | 0.10 | 0.10 | 0.10 |
| L-Lysine | 0.40 | 0.40 | 0.60 | 0.60 | 0.60 | 0.60 | 0.60 |
| L-Threonine | 0.25 | 0.25 | 0.25 | 0.25 | 0.25 | 0.25 | 0.25 |
| DL-Methionine | 0.10 | 0.10 | 0.10 | 0.10 | 0.10 | 0.10 | 0.10 |
| L-Taurine | 0.15 | 0.15 | 0.15 | 0.15 | 0.15 | 0.15 | 0.15 |
| Composition | | | | | | | |
| (as fed basis) | | | | | | | |
| Moisture, % feed | 6.2 | 6.2 | 5.4 | 6.7 | 7.0 | 7.1 | 5.7 |
| Crude protein, % feed | 42.6 | 42.2 | 42.4 | 41.9 | 42.1 | 42.1 | 42.3 |
| Crude fat, % feed | 20.2 | 20.4 | 20.2 | 20.2 | 20.1 | 20.2 | 20.2 |
| Ash, % feed | 7.4 | 7,.1 | 7.4 | 7.7 | 7.4 | 8.0 | 7.9 |
| Gross Energy, MJ/kg feed | 21.8 | 21.9 | 22.1 | 21.8 | 21.7 | 21.7 | 21.9 |
| Total P, % feed | 0.78 | 0.83 | 0.96 | 1.06 | 0.94 | 1.09 | 0.81 |
| Chromic oxide, % feed | 0.96 | 0.91 | 0.93 | 0.88 | 0.88 | 0.87 | 0.89 |

All diets had an identical level of fishmeal (15%) and krill meal (3%) as marine-derived protein sources. Diets were formulated with two levels (15 and 30%) of either soy protein concentrate (diets SOY 15 and SOY 30), sunflower protein-rich fraction 1 (D₅₀=30 μm; diets AQUASPRF1 15 and AQUASPRF1 30), sunflower protein-rich fraction 2 (D₅₀=100 μm; AQUASPRF2 15 and AQUASPRF2 30). An additional diet with 15% sunflower meal was also tested (SUN 15). Remaining ingredients (pea protein concentrate (ROQUETTE Freres, France), wheat gluten (ROQUETTE Fréres, France), corn gluten (COPAM, Portugal), soybean meal (CARGILL, Spain), wheat (Casa Lanchinha, Portugal), faba beans (Ribeiro & Sousa Cereais, Portugal) and oils (Sopropêche, France for fish oil and Henry Lamotte Oils GmbH, Germany for others vegetable oils) were adjusted in order to have all diets under isonitrogenous (crude protein: 45% DM), isolipidic (crude fat: 21.6% DM) and isoenergetic (gross energy: 23.3 MJ/kg DM) conditions. Diets were duly supplemented with essential amino acids (lysine, threonine, methionine) and taurine to avoid any nutritional deficiencies. A small portion of the various feeds were also supplemented with 1% chromic oxide as an inert marker for digestibility measurements.

3.1.c—Manufacture of Experimental Diets

Diets were manufactured by extrusion. All powder ingredients were mixed accordingly to the target formulation in a double-helix mixer (model 500 L, TGC Extrusion, France) and ground (below 400 μm) in a micropulverizer hammer mill (model SH1, Hosokawa-Alpine, Germany). Diets (pellet size: 2.5 mm) were manufactured with a twin-screw extruder (model BC45, Clextral, France) with a screw diameter of 55.5 mm. Extrusion conditions: feeder rate (80-85 kg/h), screw speed (247-266 rpm), water addition in barrel 1 (345 ml/min), temperature barrel 1 (32-34° C.), temperature barrel 3 (111-117° C.). Extruded pellets were dried in a vibrating fluid bed dryer (model DR100, TGC Extrusion, France). After cooling, oils were added by vacuum coating (model PG-10VCLAB, Dinnissen, The Netherlands). Coating conditions were: pressure (700 mbar); spraying time under vacuum (approximately 90 seconds), return to atmospheric pressure (120 seconds). Immediately after coating, diets were packed in sealed plastic buckets and shipped to the research site where they were stored at room temperature, but in a cool and aerated emplacement.

3.1.d—Fish Trials

The trial was conducted at the experimental facilities of the University of Trás-os-Montes e Alto Douro (Vila Real, Portugal). The experiment was directed by a trained scientist (accredited according to FELASA Function A: carrying out procedures on animals) and conducted by trained technical staff (accredited according to FELASA Function B: designing procedures and projects; Function C: taking care of animals) according to the EU guidelines on protection of animals used for scientific purposes (Directive 2010/63/).

3.1.e—Fish

The experimental species under testing was rainbow trout (Oncorhynchus mykiss) originated from Posto Aquicola do Torno-Marão (Amarante, Portugal). A stock of fish (approximately 1200 fish) was transferred to the experimental facilities by a duly authorized carrier and kept on sanitary quarantine for approximately 3 weeks. No mortality or pathological signs were observed in association to transport. During this period fish were fed a commercial trout feed (INICIO Vital 808 from BIOMAR). Fish were fed by hand, in two daily meals, at 1.5% biomass/day. At the start of the trial, fish were manually sorted by weight to constitute homogenous groups.

3.1.f—Growth Performance Trial

Groups of 30 fish, with a mean initial body weight (IBW) of 35.7±2.1 g, were randomly allotted to 28 quadrangular tanks (volume: 350 L). Tanks were located outdoors, supplied with flow-through freshwater (flow rate: 3.7 L/min; temperature 12.4±0.7° C., dissolved oxygen above 7.7 mg/L). Tanks were subjected to a natural photoperiod during the Winter season (December/March). Water quality parameters including dissolved oxygen, temperature and pH were monitored throughout the trial. Water parameters remained stable during the whole study without any significant change

Each replicate tank was fed one of the seven diets during 94 days. Fish were fed to apparent satiety, by hand, three times a day (9.00, 14.00 and 17.00 h) during week days and twice a day during weekends (10.00 and 16.00 h), with utmost care to avoid feed losses. Distributed feed was quantified throughout the trial. Anesthetized fish were group weighed at the start of the trial, at day 32, day 62 and day 94. At start, 10 fish from the same initial stock were sampled and stored at −20° C. for subsequent whole-body composition analysis. After 94 days of experimental feeding, 6 fish from each tank were sampled for the same purpose.

3.1.g—Apparent Digestibility Measurements

The remaining fish from each replicate tank were used to determine the apparent digestibility coefficients (ADC) of the diets, by the indirect method with diets containing chromic oxide as inert tracer. Fish were fed the chromic oxide diets for 10 days, following identical procedures as those adopted during the growth performance trial. Approximately 6 hours following the morning meal, 12 fish per replicate tank were used to collect feces by manual stripping. For this procedure, fish were lightly anesthetised and feces stripped by applying a gentle pressure to the ventral abdominal area, beginning just posterior to the pelvic fins and moving posteriorly to the anal opening. Feces of the 12 fish per tank were pooled into a plastic container and stored frozen at −20° C. prior to subsequent analysis.

3.1.h—Analytical Methods

Analysis of diets, whole-fish and feces were made with analytical duplicates and following in most cases the methodology described by AOAC (2006; Official Methods of Analysis of AOAC International, 18th ed., Rev. 1, Association of Official Analytical Chemists, Washington, USA.). Dry matter after drying at 105° C. for 24 h; total ash by combustion (550° C. during 6 h) in a muffle furnace; crude protein (N×6.25) by a flash combustion technique followed by a gas chromatographic separation and thermal conductivity detection with a Leco N Analyzer (Model FP-528, Leco Corporation, USA); crude lipid by petroleum ether extraction (40-60° C.) using a Soxtec™ 2055 Fat Extraction System (Foss, Denmark), with prior acid hydrolysis with 8.3 M HCl; gross energy in an adiabatic bomb calorimeter (Werke C2000, IKA, Germany); total phosphorus according to ISO 27085:2009 by ICP-AES methodology (ISO 27085:2009 Animal feeding stuffs. Determination of calcium, sodium, phosphorus, magnesium, potassium, iron, zinc, copper, manganese, cobalt, molybdenum, arsenic, lead and cadmium by ICP-AES. International Organization for Standardization, Geneva. 24 pp.); phytate phosphorus in the feeds was determined by a colorimetric method involving a wet ashing step followed by phosphorous measurement with 1-amino-2-naphthol-4-sulfonic acid-molybdate in a microplate reader at 660 nm (Brooks et al., 2001, Proposed phytic acid standard including a method for its analysis. J. AOAC Int., 84: 1125-1129); yttrium concentration in feed and feces was determined by atomic absorption spectrometry (SpectrAA 220 FS, Varian) (Reis et al., 2008, A fast and simple methodology for determination of yttrium as an inert marker in digestibility studies. Food Chem., 108: 1094-1098).

3.1.i—Evaluation Criteria

IBW (g): Initial mean body weight.

FBW (g): Final mean body weight.

Specific growth rate, SGR (%/day): (Ln FBW−Ln IBW)×100/days.

Feed conversion ratio, FCR: crude feed intake/weight gain.

Feed intake, FI (% BW/day): (crude feed intake/(IBW+FBW)/2/days)×100.

Protein efficiency ratio, PER: wet weight gain/crude protein intake.

$$Retention ( \% ) = 100 \times \frac{( FBM \times NFF ) - ( IBW \times NIF )}{Nutrient intake}$$

NFF: Nutrient content of final fish.

NIF: Nutrient content of initial fish.

Apparent digestibility coefficients (ADC) of dietary nutrients and energy in the experimental diets were calculated according to NRC (National Research Council, 2011, Nutrient Requirements of Fish and Shrimp. Washington, D.C.: The National Academies Press, 376p.):

$$ADC , \% = 100 \times \frac{\% marker diet}{\% marker feces} \times \frac{\% nutrient feces}{\% nutrient diet}$$

3.1.j—Statistical Analysis

Data are presented as mean of four replicates±standard deviation. Data were subjected to a multivariate statistical analysis (General Linear Analysis), with protein source and formula incorporation level as variables. When appropriate, means were compared by the Student-Newman-Keuls test. Prior to ANOVA, values expressed as percentage were subjected to arcsin square root transformation. Statistical significance was tested at 0.05 probability level. All statistical tests were performed using the IBM SPSS Statistics software (version 21).

3.2—Results

3.2.a—Growth Performance

Data on overall growth performance of rainbow trout fed for 32. 62 and 94 days with the different experimental diets is reported in Tables VI, VII and VIII.

After 32 days of experimental feeding (Table VI), no mortality was observed. Final body weight (FBW) ranged between 59 and 64 grams and fish from the best performing treatments showed a 1.8-fold increase of initial body weight (IBW). Fish fed diet SUN 15 (sunflower meal) showed a significantly lower FBW and specific growth rate (SGR) than those fed diets all diets with the various plant protein compositions (P<0.05). No statistical differences were found amongst the various plant protein compositions in terms of FBW and SGR (P>0.05). The increase on the formulation inclusion level from 15% to 30% of the various plant protein compositions led to a significant reduction of FBW and SGR (P<0.05). The feed conversion ratio (FCR) varied between 0.92 and 1.08. Fish fed all diets with the various plant protein compositions had a significantly lower FCR than those fed diet SUN 15 (P<0.05). No statistical differences were found amongst the various plant protein compositions in terms of FCR (P>0.05). Feed intake (FI) varied between 1.57 and 1.69 and fish fed diets SOY 15 and SOY 30 showed a significantly lower feed intake that those fed diets with the SPRF2 (diets AQUASPRF2 15 and AQUASPRF2 30) and sunflower meal (SUN 15) (P<0.05). Fish fed diet SUN 15 showed a significantly lower protein efficiency ratio (PER) than those fed diets all diets with the various plant protein compositions (P<0.05). No statistical differences were found amongst the various plant protein compositions in terms of PER (P>0.05). The increase on the formulation inclusion level from 15 to 30% of the various plant protein compositions had no significant effect on FCR, FI and PER (P>0.05).

TABLE VI
Growth performance after 32 days of feeding.

| | SOY | SOY | AQUASPRF1 | AQUASPRF2 | AQUASPRF2 | AQUASPRF2 | SUN |
|---|---|---|---|---|---|---|---|
| | 15 | 30 | 15 | 30 | 15 | 30 | 15 |
| IBW, g | 35.8 ± 0.2 | 36.0 ± 0.4 | 35.4 ± 0.5 | 35.5 ± 0.4 | 35.8 ± 0.5 | 36.0 ± 0.4 | 35.7 ± 0.3 |
| FBW, g | 63.7 ± 0.6 | 62.7 ± 0.8 | 62.3 ± 1.5 | 62.0 ± 2.3 | 64.2 ± 0.4 | 62.3 ± 0.5 | 59.4 ± 0.6 |
| SGR, %/d | 1.80 ± 0.03 | 1.73 ± 0.05 | 1.77 ± 0.10 | 1.74 ± 0.15 | 1.82 ± 0.06 | 1.72 ± 0.02 | 1.59 ± 0.02 |
| FCR | 0.92 ± 0.01 | 0.93 ± 0.03 | 0.98 ± 0.08 | 0.98 ± 0.07 | 0.92 ± 0.03 | 0.98 ± 0.03 | 1.08 ± 0.03 |
| FI, % ABW/d | 1.60 ± 0.01 | 1.57 ± 0.04 | 1.69 ± 0.05 | 1.66 ± 0.03 | 1.63 ± 0.10 | 1.65 ± 0.04 | 1.69 ± 0.04 |
| PER | 2.56 ± 0.03 | 2.54 ± 0.07 | 2.41 ± 0.19 | 2.44 ± 0.17 | 2.59 ± 0.09 | 2.42 ± 0.06 | 2.19 ± 0.07 |

Values are means and standard deviation (n = 4).

After 62 days of experimental feeding (Table VII), no mortality was observed. Final body weight (FBW) ranged between 101 and 117 grams and fish from the best performing treatment showed a 3.3-fold increase of initial body weight (IBW). Fish fed diet SUN 15 showed a significantly lower FBW, SGR and PER than those fed diets with the various plant protein compositions (P<0.05). The feed conversion ratio (FCR) varied between 0.87 and 1.04 and fish fed all diets with the various plant protein compositions had a significantly lower FCR than those fed diet SUN 15 (P<0.05). No statistical differences were found amongst the various diets with plant protein compositions (SOY, AQUASPRF1 and AQUASPRF2) in terms of FBW, SGR, FCR, and PER (P>0.05). The increase on the formulation inclusion level from 15 to 30% of the various plant protein compositions led to a significant reduction of FBW, SGR, PER and significant increase of FCR (P<0.05). Feed intake (FI) varied between 1.48 and 1.61. Fish fed diets with the soy protein concentrate (SPC) and SPRF2 (SOY 15, SOY 30, AQUASPRF2 15 and AQUASPRF2 30) showed a significantly lower feed intake that those fed diets with the SPRF 1 (diets AQUASPRF1 15 and AQUASPRF1 30) and sunflower meal (SUN 15) (P<0.05). Moreover, fish fed the diet with sunflower meal (SFM) showed a significantly higher feed intake than those fed diets with the SPRF1 (P<0.05). The increase on the formulation inclusion level from 15 to 30% of the various plant protein compositions led to a significant increase of feed intake (P<0.05).

TABLE VII
Growth performance after 62 days of feeding.

| | SOY | SOY | AQUASPRF1 | AQUASPRF1 | AQUASPRF2 | AQUASPRF2 | SUN |
|---|---|---|---|---|---|---|---|
| | 15 | 30 | 15 | 30 | 15 | 30% | 15 |
| IBW, g | 35.8 ± 0.2 | 36.0 ± 0.4 | 35.4 ± 0.5 | 35.5 ± 0.4 | 35.8 ±0.5 | 36.0 ± 0.4 | 35.7 ± 0.3 |
| FBW, g | 113.2 ± 1.8 | 108.0 ± 2.3 | 112.6 ± 2.7 | 110.0 ± 2.4 | 116.6 ± 1.0 | 110.2 ± 1.9 | 101.3 ± 1.7 |
| SGR, %/d | 1.86 ± 0.02 | 1.77 ± 0.03 | 1.87 ± 0.06 | 1.82 ± 0.05 | 1.91 ± 0.03 | 1.81 ± 0.03 | 1.68 ± 0.04 |
| FCR | 0.89 ± 0.01 | 0.94 ± 0.02 | 0.91 ± 0.04 | 0.95 ± 0.03 | 0.87 ± 0.02 | 0.94 ± 0.02 | 1.04 ± 0.05 |
| FI, % ABW/d | 1.49 ± 0.02 | 1.52 ± 0.02 | 1.53 ± 0.04 | 1.57 ± 0.02 | 1.48 ± 0.04 | 1.54 ± 0.01 | 1.61 ± 0.05 |
| PER | 2.65 ± 0.03 | 2.51 ± 0.05 | 2.59 ± 0.12 | 2.50 ± 0.07 | 2.74 ± 0.05 | 2.53 ± 0.05 | 2.28 ± 0.11 |

Values are means and standard deviation (n = 4).

At the end of the trial (94 days of experimental feeding; Table VII), a total of 5 fish died (99.4% survival) although without any clear association to dietary treatments. Final body weight (FBW) ranged between 128 and 147 grams and fish from the best performing treatment showed a 4-fold increase of initial body weight (IBW). The feed conversion ratio (FCR) varied between 0.93 and 1.20. Fish fed diet SUN 15 showed a significantly lower FBW, SGR, PER and higher FCR and feed intake than those fed diets all other diets (P<0.05). No statistical differences were found amongst the various diets with plant protein compositions (SOY, AQUASPRF1 and AQUASPRF2) in terms of FBW, SGR, FCR, FI and PER (P>0.05). The increase on the formulation inclusion level from 15 to 30% of the various plant protein compositions led to a significant reduction of FBW, SGR, PER (P<0.05) and a significantly increase of FCR and feed intake (P<0.05). The granulometry of the sunflower protein-rich fraction according to the invention (SPRF1<30 μm and SPRF2<100 μm) had no effect on the overall performance criteria (P>0.05).

TABLE VII
Growth performance after 94 days of feeding.

| | SOY | SOY | AQUASUN1 | AQUASUN1 | AQUASUN2 | AQUASUN2 | SUN |
|---|---|---|---|---|---|---|---|
| | 15 | 30 | 15 | 30 | 15 | 30 | 15 |
| IBW, g | 35.8 ± 0.2 | 36.0 ± 0.4 | 35.4 ± 0.5 | 35.5 ± 0.4 | 35.8 ± 0.5 | 36.0 ± 0.4 | 35.7 ± 0.3 |
| FBW, g | 146.8 ± 2.7 | 141.8 ± 2.6 | 147.2 ± 1.8 | 143.7 ± 2.5 | 146.5 ± 2.1 | 142.8 ± 1.5 | 128.3 ± 2.9 |
| SGR, %/d | 1.50 ± 0.02 | 1.46 ± 0.03 | 1.52 ± 0.01 | 1.49 ± 0.02 | 1.50 ± 0.02 | 1.47 ± 0.01 | 1.36 ± 0.03 |
| FCR | 0.95 ± 0.03 | 1.03 ± 0.02 | 0.93 ± 0.02 | 1.01 ± 0.03 | 0.95 ± 0.02 | 1.03 ± 0.02 | 1.20 ± 0.04 |
| FI, % ABW/d | 1.22 ± 0.02 | 1.30 ± 0.02 | 1.22 ± 0.03 | 1.29 ± 0.02 | 1.22 ± 0.02 | 1.31 ± 0.02 | 1.45 ± 0.04 |
| PER | 2.48 ± 0.07 | 2.31 ± 0.05 | 2.52 ± 0.05 | 2.37 ± 0.07 | 2.51 ± 0.04 | 2.31 ± 0.04 | 1.97 ± 0.06 |

Values are means and standard deviation (n = 4).

3.2.b—Whole-Body Composition

Data on the whole-body composition of fish at the end of the trial is presented in Table VIII. Dietary treatments had no effect on the whole-body composition of fish in terms of moisture, ash, protein, fat and energy (P>0.05). However, fish fed the soy-based diets (SOY 15 and SOY 30) had a significantly lower whole-body phosphorus content than those fed all other diets (P<0.05).

TABLE VIII
Whole-body composition of fish fed the various dietary treatments.

| | SOY | SOY | AQUASUN1 | AQUASUN1 | AQUASUN2 | AQUASUN2 | SUN |
|---|---|---|---|---|---|---|---|
| | 15 | 30 | 15 | 30 | 15 | 30 | 15 |
| Moisture, % | 71.92 ± 0.65 | 71.35 ± 0.64 | 72.17 ± 1.36 | 71.72 ± 1.03 | 71.97 ± 0.36 | 72.05 ± 0.74 | 72.49 ± 0.62 |
| Ash, % | 2.04 ± 0.20 | 2.25 ± 0.36 | 2.36 ± 0.29 | 2.33 ± 0.23 | 2.17 ± 0.02 | 2.10 ± 0.07 | 2.16 ± 0.15 |
| Protein, % | 15.61 ± 0.49 | 15.85 ± 0.07 | 15.60 ± 0.42 | 15.38 ± 0.42 | 15.87 ± 0.48 | 15.84 ± 0.21 | 15.82 ± 0.33 |
| Fat, % | 9.77 ± 0.57 | 10.05 ± 0.44 | 9.54 ± 0.66 | 10.22 ± 0.98 | 9.41 ± 0.36 | 9.61 ± 0.53 | 9.36 ± 0.13 |
| Phosphorus, % | 0.58 ± 0.01 | 0.60 ± 0.02 | 0.59 ± 0.03 | 0.65 ± 0.02 | 0.61 ± 0.01 | 0.68 ± 0.02 | 0.64 ± 0.01 |
| Energy, kJ/g | 7.21 ± 0.20 | 7.36 ± 0.16 | 7.12 ± 0.32 | 7.32 ± 0.39 | 7.13 ± 0.12 | 7.20 ± 0.22 | 7.10 ± 0.12 |

Values are means and standard deviation (n = 4).

Initial fish: moisture 72.29%; ash 3.27%; protein 15.26%; fat 8.71%; phosphorus 0.68%; energy 6.73 kJ/g.

3.2.c—Nutrient Retention

Values for nutrient and energy retention (expressed as percentage of intake) are presented in Table IX. Fish fed diet SUN 15 showed a significantly lower retention of protein, fat and energy than those fed all other diets (P<0.05). Moreover, fish fed the soy protein concentrate diets (SOY 15 and SOY 30) showed a significantly higher phosphorus retention than all other diets (P<0.05). The increase on the formulation inclusion level from 15 to 30% of the various plant protein compositions led to a significant reduction on the retention of protein, phosphorus and energy (P<0.05).

TABLE IX
Nutrient and energy retention of seabream fed the various dietary treatments.

| | SOY | SOY | AQUASPRF1 | AQUASPRF1 | AQUASPRF2 | AQUASPRF2 | SUN |
|---|---|---|---|---|---|---|---|
| | 15 | 30 | 15 | 30 | 15 | 30 | 15% |
| Protein, % | 38.86 ± 2.45 | 36.87 ± 1.06 | 39.64 ± 1.44 | 36.54 ± 1.47 | 40.14 ± 1.69 | 36.96 ± 0.78 | 31.26 ± 1.37 |
| Fat, % | 52.63 ± 3.72 | 50.38 ± 3.58 | 52.04 ± 5.21 | 52.88 ± 6.54 | 50.49 ± 2.92 | 47.68 ± 2.98 | 39.28 ± 1.57 |
| Phosphorus, % | 74.60 ± 3.21 | 68.14 ± 4.88 | 62.97 ± 4.96 | 60.33 ± 3.45 | 65.49 ± 1.46 | 60.12 ± 1.75 | 62.75 ± 3.17 |
| Energy, % | 35.51 ± 1.59 | 33.63 ± 1.54 | 35.13 ± 2.37 | 34.33 ± 2.45 | 35.20 ± 1.15 | 32.91 ± 1.06 | 27.22 ± 1.11 |

Values are means and standard deviation (n = 4).

3.2.d—Apparent Digestibility

The apparent digestibility coefficients (ADC) for dry matter, protein, fat, phosphorus and energy were not significantly affected by dietary treatments (P>0.05) (Table X). Diet SUN 15 showed a significantly lower digestibility of protein, fat, energy and phosphorus (P<0.05). Phosphorus digestibility in the AQUASPRF1 diets was higher than that measured in the SOY and AQUASPRF2 diets (P<0.05).

TABLE X
Apparent digestibility coefficients (ADC) of nutrients and energy.

| | SOY | SOY | AQUASPRF1 | AQUASPRF1 | AQUASPRF2 | AQUASPRF2 | SUN |
|---|---|---|---|---|---|---|---|
| | 15 | 30 | 15 | 30 | 15 | 30 | 15 |
| Dry matter, % | 70.2 ± 1.3 | 70.4 ± 1.1 | 69.9 ± 0.6 | 70.9 ± 2.4 | 70.0 ± 0.9 | 70.8 ± 1.8 | 64.6 ± 1.4 |
| Protein, % | 91.3 ± 0.4 | 91.3 ± 0.8 | 91.4 ± 0.4 | 91.2 ± 1.3 | 91.7 ± 0.4 | 91.6 ± 0.6 | 87.6 ± 0.5 |
| Fat, % | 91.8 ± 0.7 | 91.5 ± 0.6 | 91.1 ± 1.3 | 91.0 ± 0.8 | 90.5 ± 1.8 | 91.0 ± 0.9 | 88.6 ± 1.5 |
| Phosphorus, % | 44.9 ± 2.3 | 47.5 ± 3.9 | 51.4 ± 2.7 | 55.6 ± 2.8 | 43.2 ± 2.6 | 46.8 ± 4.6 | 41.3 ± 3.7 |
| Energy, % | 93.2 ± 1.0 | 93.6 ± 0.1 | 92.8 ± 0.4 | 93.4 ± 0.4 | 93.4 ± 0.3 | 93.5 ± 0.5 | 90.6 ± 0.4 |

Values are means and standard deviation (n = 4).

3.3—Conclusion

This study was undertaken to compare the effect of a sunflower protein rich fraction according to the invention to various plant protein sources on the growth performance, whole body composition, nutrient retention and apparent digestibility in rainbow trout.

At the exception of treatment SUN 15 (with high levels of sunflower meal), fish fed the diets with the various plant protein composition from soy and sunflower showed a good performance, with a 4-fold increase of the initial body weight in 94 days. The specific growth rates observed with the diets rich in plant protein compositions (1.46 to 1.52%/day) is within the normal range for the species reared at 12° C. and suggests a good nutritional adequacy of the various diets. However, overall data confirms that irrespective of the plant protein composition source (soy or sunflower) an increase on the formulation level from 15 to 30% resulted in lower growth performance in terms of weight gain, feed conversion and nutrient retention.

After 94 days of experimental feeding, fish fed the SUN 15 diet showed a significantly lower FBW, SGR, PER and higher FCR and feed intake than those fed diets all other diets. Although balanced in terms of crude levels of protein, essential amino acids, fat and energy, diet SUN 15 showed a lower digestibility of protein, fat, energy and phosphorus. Without wishing to be bound by a particular theory, this fact, probably associated to a higher fibre content, has surely conditioned the nutritional value of this diet on a digestible basis.

At the same incorporation level, the use of the various plant protein composition (SPC, SPRF1 and SPRF2) resulted in a similar zootechnical performance in terms of FBW, SGR, FCR, FI and PER. Both retention and digestibility of protein, fat and energy confirm a relative equivalency between the various plant protein compositions. The sunflower protein-rich fractions according to the invention (SPRF1 and SPRF2) are therefore valid protein sources for usage in trout feeds.

Sunflower protein-rich fractions presented in two granulometries (SPRF1<30 μm and SPRF2<100 μm) were also compared in this study. For most of the evaluated criteria fine grinding below 30 μm had no beneficial effects on performance of fish. When comparing both products, the only advantage of fine grinding (<30 μm) was the higher digestibility of phosphorus observed with the AQUASPRF1 diets.

### Example 4—Comparison of the Apparent Digestibility of Two Sunflower Protein-Protein-Rich Fractions (SPRF) in Rainbow Trout

This study was undertaken to evaluate the apparent digestibility of protein, fat, phosphorus, energy and essential amino acids in sunflower protein-protein-rich fractions according to the invention fed to rainbow trout (Oncorhynchus mykiss).

4.1—Materials and Methods

4.1.a—Test Ingredients
SPRF46: sunflower protein-rich one-pass fraction (“first pass”) obtained according to Example 1 above from a sunflower meal which has a D₅₀ of 50 μm.
SPRF52: sunflower protein-rich two-pass fraction (“second pass”) obtained according to Example 1 above from a sunflower meal which has a D₅₀ of 50 μm.

The test ingredients were supplied in a ready to use powder form.

The proximate composition and amino acid profile of the test products is reported in Table XI. The methods of analysis are described in Example 1.

TABLE XI
Proximate and amino acids
composition of test ingredients.

| | SPRF 46 | SPRF 52 |
|---|---|---|
| Dry Matter (%) | 92.60 | 92.30 |
| Protein (% DM) | 51.94 | 56.99 |
| Lipids (% DM) | 2.48 | 1.84 |
| Energy (kJ/g DM) | 19.32 | 19.66 |
| Ash (% DM) | 9.07 | 8.67 |
| Phosphorus (% DM) | 1.91 | 1.91 |
| Cellulose (% DM) | 9.94 | 5.85 |
| NDF (% MS) ( | 12.96 | 8.88 |
| ADF (% MS) | 9.29 | 5.53 |
| ADL (% MS) | 2.27 | 0.54 |
| Glucosinolates (μmol/gMS) | — | — |
| Polyphenols (% MS) | 3.56 | 3.68 |
| Phytic acid (% MS) | 5.49 | 5.45 |
| Arginine | 4.5 | 4.9 |
| Histidine | 1.5 | 1.6 |
| Isoleucine | 2.2 | 2.4 |
| Leucine | 3.4 | 3.6 |
| Lysine | 2.0 | 2.1 |
| Methionine | 1.2 | 1.2 |
| Phenylalanine | 2.5 | 2.7 |
| Threonine | 2.0 | 2.1 |
| Tryptophane | 0.7 | 0.9 |
| Valine | 2.6 | 2.7 |

4.1.b—Experimental Diets

The trial comprised 3 experimental diets (Tables XII and XIII): a reference diet (REF) with a high level of fishmeal (50%) and moderate levels of wheat gluten, soybean meal, wheat meal and fish hydrolysates. This reference formulation was supplemented with 0.05% (500 mg/kg) of yttrium oxide as an inert digestibility marker; and 5 test diets with 75% of the same basal mixture of the reference diet and 25% of each individual test ingredient (coded as AQUAREF, AQUASPRF 46, AQUASPRF 52).

4.1.b—Manufacture of Experimental Diets

Diets were manufactured by extrusion. All powder ingredients were mixed accordingly to the target formulation in a double-helix mixer and ground (below 400 μm) in a micropulverizer hammer mill. Diets (pellet size: 2.5 mm) were manufactured with a twin-screw extruder (model BC45, Clextral, France) with a screw diameter of 55.5 mm. Extrusion conditions: feeder rate (80-85 kg/h), screw speed (247-266 rpm), water addition in barrel 1 (345 ml/min), temperature barrel 1 (32-34° C.), temperature barrel 3 (111-117° C.). Extruded pellets were dried in in a ventilated drying oven (35° C.) before bagging. Immediately after coating, diets were packed in sealed plastic buckets. These feedstuffs were kept cold (+4° C.) until they were distributed to the fish.

TABLE XII
Formulation and proximate composition of the experimental diets.

| Ingredients (%) | REF | | |
|---|---|---|---|
| Fishmeal | 50.00 | | |
| Wheat meal | 19.95 | | |
| Wheat gluten | 10.00 | | |
| Soybean meal | 10.00 | | |
| Fish hydrolysates | 5.00 | | |
| CPSP G | | | |
| Vitamin & Mineral | 5.00 | | |
| Premix | | | |
| Yttrium oxide | 0.05 | | |
| | AQUAREF | AQUASPRF 46 | AQUASPRF 52 |
| DIET 1 | 100 | | |
| DIET2 | 75.00 | 25.00 | |
| DIET 3 | 75.00 | | 25.00 |
| Dry matter, % | 96.26 | 96.89 | 96.89 |
| Energy, kJ/g DM | 19.84 | 19.77 | 19.79 |
| Protein, % DM | 57.74 | 57.61 | 56.26 |
| Ash, % DM | 12.94 | 11.7 | 11.83 |
| P, % DM | 1.61 | 1.72 | 1.68 |
| Yttrium, mg/kg DM | 0.07 | 0.05 | 0.05 |

TABLE XIII
Amino acid composition of the experimental diets (% DM).

| | AQUAREF | AQUASPRF 46 | AQUASPRF 52 |
|---|---|---|---|
| Arginine | 3.1 | 3.53 | 3.33 |
| Histidine | 1.32 | 1.37 | 1.33 |
| Isoleucine | 2.18 | 2.22 | 2.13 |
| Leucine | 3.88 | 3.79 | 3.65 |
| Lysine | 2.52 | 3.2 | 3.09 |
| Methionine | 1.32 | 1.29 | 1.24 |
| Phenylalanine | 2.29 | 2.34 | 2.26 |
| Threonine | 2.08 | 2.07 | 1.99 |
| Tryptophane | 0.53 | 0.64 | 0.59 |
| Valine | 2.34 | 2.43 | 2.36 |

4.1.c—Fish Trials

The trial was conducted in the experimental structures (technical platform) of the INRA Hydrobiology Cluster in Saint-Pee-sur-Nivelle, UMR NuMeA (Nutrition, Metabolism, Aquaculture).

4.1.d—Fish

The experimental species under testing was rainbow trout (Oncorhynchus mykiss). A stock of fish (approximately 270 fish) was transferred from fish farm (Donzacq, France) to the experimental facilities by a duly authorized carrier.

4.1.e—Apparent Digestibility Measurements

Groups of 15 fish, with a mean body weight (BVV) of 120 g, were used to determine the apparent digestibility coefficients (ADC) of the dietary components, by the indirect method with diets containing yttrium oxide as inert tracer.

The digestibility layout is composed of a set of cylindrical-conical bins with a working volume of 150 liters fed by a circuit in recycled water, thermoregulated, including a decanter and a biological filter (nitrogen purifier). Facing each ramp of 6 bins, there is an automatic collector with rotating grids (Choubert et al., 1982. Digestibility in fish: improved device for the automatic collection of feces. Aquaculture 29, 185-189). The discharge water from the cylindro-conical tanks is continuously filtered on metal grids, whose rotation is driven by an electric motor. The meshed pallets follow one another horizontally in a continuous movement under the water outlet of the tank. The water passes through the grate, the feces remain on the surface and are thus separated from the water. Once they are no longer under the water outlet, the pallets pass in a vertical position, then abut on a metal structure, and the feces fall into the collecting containers. The leaching is thus minimized; indeed, the residence time of the feces in the water is very short (about 5 to 10 seconds thanks to the cylindro-conical shape of the tanks and the controlled water flow).

During the test, the water flow in the tanks was kept between 4 and 6 liters/minute in order to quickly drive the feces to the collector and thus prevent their leaching.

The dissolved oxygen content of the water was monitored daily and maintained at 9.5 ppm and around 8 ppm at the pond outlet. The nitrogen purification of the water of the basins is maximum, the content of N—NH4 is zero at the output of the biological filter. The temperature of the water is set at 17+/−0.5° C. and the period of illumination was 12 hours (8 h-20 h).

Prior to the start of feces collection, fish were adapted over 7 days to the experimental diet. Fish were fed twice a day, by hand in slight excess. Feces were collected once a day, before the morning meal. In order to avoid any “contamination” with uneaten feed, the rotation of the automatic faeces collection system was interrupted during feedstuff distribution. At the end of the feedstuff distribution, the grids were cleaned and the trays intended to harvest the faeces put back in place. For each group of trout, the faeces were collected in an aluminium tray and held at −20° C. until lyophilization.

4.1.f—Analytical Methods

Before analysis, the 18 batches of frozen feces were lyophilized. The lyophilizates were crushed again to ensure the homogeneity of the samples. The raw materials to be tested and the feedstuff were also crushed before analysis.

The dry matter content was determined from the measurement of water loss of the samples evaluated by weight difference of the test portion, before and after drying, for 24 hours in an oven at 105° C.

The ash content was determined after combustion at 550° C. for 12 hours.

The raw energy was measured using an adiabatic calorimeter (IKA C4000) from the amount of heat released by the combustion of the known mass sample, under oxygen pressure of 25 atmospheres.

Yttrium content (inert label) is determined on ash using the Agilent Microwave Plasma Atomic Emission Spectrometer (Agilent 4200 MP-AES) after acid mineralization (ISO 27085: 2009 method).

4.1.g—Evaluation Criteria

Apparent digestibility coefficients (ADC) of dietary nutrients and energy in the experimental diets were calculated according to NRC (2011):

$$ADC , \% = 100 \times [ \frac{\% yttrium diet}{\% yttrium feces} \times \frac{\% nutrient feces}{\% nutrient diet} ]$$

Subsequently, the apparent digestibility coefficients of the test ingredients were calculated according to NRC (2011):

ADC Test Ingredient (%)=ADC_{TD}+(ADC_{TD}−ADC_{RD})×(Y×N_{RD})/(Z×N_{TI})

ADC_{TD}: ADC of test diet (%)

ADC_{RD}: ADC of reference diet (%)

Y=% of basal reference formula (75%)

Z=% of test ingredient (25%)

N_{RD}: Nutrient content in the reference diet (% or kJ/g)

N_{TI}: Nutrient content in the test ingredient (% or kJ/g)

4.1.g—Statistical Analysis

ADC data are presented as mean of three replicates±standard deviation. Data were subjected to a one-way analysis of variance and when appropriate, means were compared by the Student-Newman-Keuls test. ADC values were subjected to arcsin square root transformation. Statistical significance was tested at 0.05 probability level. All statistical tests were performed using the SPSS V18 software.

4.2.—Results

4.2.a—Feces Composition

The feces composition of trout fed the various experimental diets is presented in Table XIV.

TABLE 4
Composition of trout feces.

| | AQUAREF | AQUASPRF 46 | AQUASPRF 52 |
|---|---|---|---|
| Yttrium, mg/kg DM | 0.32 | 0.20 | 0.19 |
| Protein, % DM | 16.86 | 16.41 | 14.91 |
| DM, % | 96.94 | 97.07 | 96.96 |
| Phosphorus, % DM | 5.06 | 4.52 | 4.50 |
| Energy, kJ/g DM | 12.27 | 12.58 | 13.06 |

4.2.b—Apparent Digestibility Coefficients of Experimental Diets

The apparent digestibility coefficients (ADC) of dry matter, protein, fat, phosphorus, energy and essential amino acids in the experimental diets are presented in Table XV.

TABLE 5
ADC of experimental diets in rainbow trout.

| | AQUAREF | AQUASPRF 46 | AQUASPRF 52 |
|---|---|---|---|
| Dry matter, % | 79.07 | 75.55 | 75.04 |
| Protein, % | 93.88 | 93.03 | 93.38 |
| Phosphorus, % | 34.38 | 35.82 | 33.32 |
| Energy, % | 87.05 | 84.43 | 83.52 |
| Arg, % | 96.08 | 94.31 | 94.78 |
| His, % | 94.68 | 91.60 | 92.15 |
| Ile, % | 95.21 | 92.62 | 93.27 |
| Leu, % | 95.46 | 92.90 | 93.52 |
| Lys, % | 94.84 | 92.52 | 93.07 |
| Thr, % | 94.63 | 91.25 | 91.66 |
| Val, % | 95.20 | 92.36 | 93.03 |
| Met, % | 95.80 | 94.03 | 94.44 |
| Cys, % | 93.09 | 88.56 | 89.77 |
| Phe, % | 94.24 | 91.86 | 92.63 |
| Tyr, % | 90.77 | 84.89 | 85.13 |

4.2.c—Apparent Digestibility of Test Ingredients

The apparent digestibility coefficients (ADC) of protein, fat, phosphorus, energy and essential amino acids in the test ingredients are presented in Table XVI.

TABLE 6
ADC of test ingredients in rainbow trout.

| | AQUASPRF 46 | AQUASPRF 52 |
|---|---|---|
| Protein, % | 89.3 ± 1.4 | 91.4 ± 0.4 |
| DM, % | 61.1 ± 3.9 | 58.4 ± 0.5 |
| Phosphorus, % | 40.7 ± 18 | 29.7 ± 4.2 |
| Energy, % | 73.7 ± 2.8 | 69.3 ± 1.0 |
| Essential Amino Acids | | |
| Arg, % | 89.2 ± 0.8 | 91.3 ± 0.4 |
| His, % | 79.8 ± 1.1 | 83.1 ± 0.8 |
| Ile, % | 82.0 ± 1.5 | 85.8 ± 0.7 |
| Leu, % | 80.7 ± 1.8 | 84.8 ± 0.5 |
| Lys, % | 80.1 ± 1.6 | 83.9 ± 0.8 |
| Thr, % | 76.8 ± 1.8 | 79.5 ± 0.6 |
| Val, % | 81.5 ± 1.4 | 85.2 ± 0.8 |
| Met, % | 85.7 ± 1.3 | 88.4 ± 0.1 |
| Cys, % | 72.7 ± 2.3a | 78.8 ± 0.7b |
| Phe, % | 82.8 ± 1.6 | 86.9 ± 0.5 |
| Tyr, % | 55.3 ± 4.8 | 57.7 ± 4.6 |

Values are means ± standard deviation (n = 3).

4.3—Conclusion

Digestibility results showed that compared with soy protein concentrate and sunflower meal, AQUASPRF 46 and 52 improved protein digestibility from 0.1 to 4.3% respectively, phosphorus digestibility from 14.5 to 24.5% respectively and energy from 0.2% to 2.4% respectively. The two protein-rich fractions SPRF 46 an SPRF 52 according to the invention show a high protein content (51.94% and 56.99% DM), and this high protein content is associated with high digestibility of these proteins and also overall amino acids. This suggests that these protein-rich fractions are very interesting raw materials for salmonid feedstuffs.

Results from the trials also demonstrated that compared with soy protein concentrate and sunflower meal, AQUASPRF improved final weight gain from 0.3% to 14.7% respectively, feed conversion ration from 2.1% to 22.5% respectively and protein efficiency ratio from 1.6% to 27.4 respectively.

Another field trial run in France with AQUASPRF 46 applied in Rainbow trout (Oncorhynchus mykiss) consolidated those trends. Final results after 61 days of experiment indicated that the SPRF 46 composition did not impact fish survival (+0.26%) but significantly improved fish performance and feed efficacy since final average individual weigh gain was enhanced by 11% and final feed conversion ratio was optimized by 10%.

Overall, these results indicated that the sunflower protein-rich fractions according to the present invention are much more better ingredients than sunflower derivates products like sunflower meal and can be a reliable alternative to soy protein concentrate.

1. A protein-rich fraction from an oilseed meal which is obtainable by a process of electrostatic separation, said process comprising the following steps:
a) providing a grinded particles powder of an oilseed meal, said oilseed meal having a D₅₀ ranging from 10 μm to 400 μm and a moisture content ranging from 2% to 15% in weight by total weight of said powder, to a device for electrostatic separation, said device comprising:
a feed port,
two parallel, spaced electrodes, each positioned horizontally facing one another, one of said electrode being a top electrode and the other being a bottom electrode, and an electrode gap being defined as the space between said two electrodes,
a belt traveling in a generally horizontal direction, said belt being positioned, at least partially, within said gap between said spaced electrodes, said belt forming a continuous longitudinal loop having two extremities, and having two opposite traveling belt portions which are moving in opposite directions and are configured for transporting particles of said powder to an extremity of said belt,
a first collecting container in fluid communication with one of the extremity of said belt (18) to collect the particles dropping from said belt at that one extremity;
b) applying an electrical field between said electrodes by applying to said electrode a difference of potential of 2 to 8 kV;
c) driving said belt at a speed of 15 to 25 m/s;
d) feeding said grinded particle powder to said belt via said feed port within said continuous longitudinal loop; and
e) recovering said protein fraction from said first collecting container;
wherein said oilseed meal is a sunflower seed meal or Brassica L. seed meal.

2. The protein-rich fraction of claim 1, wherein steps a) to e) are carried out on a protein fraction recovered from step e) at least once.

3. The protein-rich fraction of claim 1, wherein said top electrode has a positive polarity and said bottom electrode has a negative polarity.

4. The protein-rich fraction of claim 1, wherein said feed port is positioned close to the extremity of the belt opposite to said first collecting container.

5. The protein-rich fraction of claim 1, wherein said fraction has a moisture content which ranges from 3 to 5%, in weight, with respect of the total weight of said fraction.

6. The protein-rich fraction of claim 1, wherein said electrode gap is ranging from 1.1 to 1.3 cm.

7. The protein-rich fraction of claim 1, wherein said difference of potential is about 6 kV.

8. The protein-rich fraction of claim 1, wherein said speed of the belt is about 20 m/s.

9. The protein-rich fraction of claim 1, wherein said grinded particles have a D₅₀ being less than, or equal to, 50 μm.

10. A dry sunflower protein-rich composition, said composition comprising a dry matter content of sunflower proteins ranging from 44 to 60, in weight %, and a dry matter content of Acid Detergent Lignin ranging from 2 to 5 in weight % with respect of the total weight of dry matter of said composition.

11. A dry Brassica L. protein-rich composition, said composition comprising a dry matter content of Brassica L. proteins ranging from 40 to 50, in weight %, and a content of Acid Detergent Lignin ranging from 1.5 to 4 in weight % with respect of the total weight of dry matter of said composition.

12. A dry Brassica L. protein-rich composition of claim 11, wherein the Brassica L. is Brassica napus var napus.

13. Feed or a food or a dietary supplement or additive comprising the protein-rich fraction of claim 1, which is suitable for animal and/or human consumption.

14. The feed, food, dietary supplement or additive according to claim 13, wherein the animal is a fish or pork.

15. The protein-rich fraction of claim 1, wherein said fraction has a moisture content of 4%, in weight, with respect of the total weight of said fraction.

16. The protein-rich fraction of anyone of claim 1, wherein said electrode gap is about 1.20 cm.

17. The protein-rich fraction of claim 1, wherein said grinded particles have a D₅₀ being less than, or equal to, 25 μm.

18. The feed, food, dietary supplement or additive according to claim 13, wherein the animal is a fish.
